(19) United States
(12) Patent Application Publication
(10) Pub. No.: US 2011/0063580 A1
(43) Pub. Date: Mar. 17, 2011

(54) PROJECTION DISPLAY APPARATUS

(75) Inventors: Ryuhei AMANO, Osaka (JP); Takashi IKEDA, Osaka (JP); So SUZUKI, Osaka (JP); Hiroaki YOSHIDA, Osaka (JP); Yasuhide KOGO, Amagasaki-City (JP)

(73) Assignee: SANYO ELECTRIC CO., LTD., Moriguchi City (JP)

(21) Appl. No.: 12/891,497

(22) Filed: Sep. 27, 2010

Related U.S. Application Data
(63) Continuation of application No. PCT/JP2009/056291, filed on Mar. 27, 2009.

(30) Foreign Application Priority Data
Mar. 27, 2008 (JP) 2008-084855
Mar. 27, 2008 (JP) 2008-084856
Mar. 27, 2008 (JP) 2008-084857
Mar. 27, 2008 (JP) 2008-085038

(51) Int. Cl. G03B 21/28

(52) U.S. Cl. 353/20; 353/98

(57) ABSTRACT

A projection display apparatus (100) includes a image light generation unit (200) and a projection optical unit (300). The projection optical unit (300) has a reflecting mirror (320). The projection optical unit (300) is configured to project image light in a plurality of directions without changing the disposition of the projection display apparatus (100).

### TECHNICAL FIELD

The present invention relates to a projection display apparatus having a projection optical unit for projecting image light on a projection plane.

### BACKGROUND ART

Conventionally, there has been known a projection display apparatus having: a light valve for modulating the light emitted from a light source; and a projection lens for projecting the light emitted from the light valve on a projection plane (screen).

Hence, a long distance between the projection lens and the screen needs to be assured for displaying a large-size image on the screen. In contrast to this, a projection display system has been proposed which aims to shorten a distance between the projection display apparatus and the screen by using a reflection mirror for reflecting the light emitted from the projection lens, toward the screen side (for example, Japanese Patent Application Publication No. 2006-235516).

With the aim of shortening the distance between the projection display apparatus and the screen, the projection display apparatus becomes in proximity to the screen, and the projection display apparatus becomes within a user's field of view. Thus, there is a need to perform vertically or laterally oblique projection of the screen. For example, in the above-described projection display system, a projection distance is shortened and oblique projection is performed by shifting a positional relationship between a light valve and an optical axis of the projection optical unit in a vertical direction and employing a concave mirror as a reflection mirror.

Incidentally, as a method of setting up a projection display apparatus, there is considered a method of setting up a projection display apparatus on a floor surface or the him (hereinafter, referred to as a floor-placed setup) or a method of setting up a projection display apparatus on a ceiling or the like (hereinafter, referred to as a ceiling-suspended setup). On the other band, the disposition precision of a reflection mirror is a very important factor for appropriately displaying an image to be projected on a projection plane.

In the floor-placed setup and ceiling-suspended setup, the top and bottom of the projection display apparatus need to be inverted. That is, the direction of gravity applied to the reflection mirror provided at the projection display apparatus is reversed. Therefore, the disposition precision of the reflection mirror can be lowered owing to self-weight of the reflection mirror.

Specifically in a case where the reflection mirror is disposed while with the floor-placed setup being dealt as a target, the disposition precision of the reflection mirror lowers in the ceiling-suspended setup. Conversely, in a case where the reflection mirror is disposed with the ceiling-suspended setup being dealt as a target, the disposition precision of the reflection mirror lowers in the floor-placed setup.

### DISCLOSURE OF THE INVENTION

A first aspect of a projection display apparatus, includes: an image light generating unit (image light generating unit 200) configured to generate image light; and a projection optical unit (projection optical unit 300) configured to project the image light on a projection plane. The projection optical unit has a reflection mirror (reflection mirror 320) configured to reflect the image light emitted from the image light generating unit. The projection optical unit is configured to project the image light in a plurality of directions without changing disposition of the projection display apparatus.

A second aspect of a projection display apparatus, includes: an image light generating unit (image light generating unit 200) configured to generate image light; and a projection optical unit (projection optical unit 300) configured to project the image light on a projection plane. The projection optical unit has a reflection mirror (reflection mirror 320) configured to reflect the image light emitted from the image light generating unit. The projection display apparatus includes a support mechanism (support mechanism 500) configured to support a reflection optical element (reflection optical element 330) while a first state and a second state can be switched as a state of the reflection optical element, the reflection optical element configured to reflect the image light reflected by the reflection mirror. The first state is a state in which the reflection optical element is disposed on an optical path of the image light reflected by the reflection mirror. The second state is a state in which the reflection optical element is caused to come off from a course of the optical path of the image light reflected by the reflection mirror. The projection optical unit projects on the projection plane the image light reflected by the reflection optical element in the first state, and projects on the projection plane the image light reflected by the reflection mirror in the second state.

According to the second aspect, the support mechanism supports a reflection optical element while the first state and the second state can be switched from each other. The projection optical unit projects the image light reflected by the reflection optical element, in the first state, and projects the image light reflected by the reflection mirror, in the second state.

In this manner, floor-placed setup and ceiling-suspended setup can be switched from each other without inverting the top and bottom of the projection display apparatus. That is, the disposition precision of the reflection mirror can be appropriately maintained, since the direction of gravity applied to the reflection mirror provided to reduce a distance between the projection display apparatus and the projection plane is not reversed.

In the second aspect, the projection display apparatus includes a protection cover (protection cover 400) provided on an optical path of the image light reflected by the reflection mirror. The protection cover has an opening portion configured to transmit the image light. The opening portion includes a first opening portion (first opening portion 410) configured to transmit the image light on a side of the projection plane in the first state, and a second opening portion (second opening portion 420) configured to transmit the image light on the side of the projection plane in the second state.

In the second aspect, the projection display apparatus includes an opening control section (open/close mechanism control section 255, the open/close mechanism 600) configured to control the opening portion. The opening portion has an opening (opening 411, opening 421) configured to transmit the image light and a capping member (capping member 412, capping member 422) configured to close the opening. The opening control section controls whether or not the opening is dosed by the capping member, in accordance with a state of the reflection optical element.

In the second aspect, the projection display apparatus includes an image control section (image control section 253) configured to control an image displayed on the projection plane. The image control section controls an orientation of the image displayed on the projection plane, in accordance with the state of the reflection optical element.

In the second aspect, the reflection mirror focuses the image light between the reflection optical element and the projection plane in the first state, and focuses the image light between the reflection mirror and the projection plane in the second state. The first opening portion and the second opening portion are disposed in proximity to a position at which the image light is focused.

A third aspect of a projection display apparatus, includes an image light generating unit (image light generating unit 200) configured to generate image light; and a projection optical unit (projection optical unit 300) configured to project the image light on a projection plane. The projection optical unit has a reflection mirror (reflection mirror 320) configured to reflect the image light emitted from the image light generating unit and a half mirror (half mirror 350) provided on the optical path of the image light reflected by the reflection mirror. The reflection mirror focuses the image light emitted from the image light generating unit. The half mirror reflects one portion of the image light reflected by the reflection mirror, and transmits another portion of the image light reflected by the reflection mirror.

According to the third aspect, the half mirror reflects one portion of the image light reflected by the reflection mirror and transmits another portion of the image light reflected by the reflection mirror. Therefore, images can be displayed on two sites by means of one projection display apparatus.

Further, the reflection mirror focuses the image light emitted from the image light generating unit, and the half mirror is provided on the optical path of the image light reflected by the reflection mirror. Therefore, upsizing of the projection display apparatus can be restrained.

In this manner, in a case in which images are displayed on a plurality of projection plane, even where an attempt is made to reduce a distance between the projection display apparatus and each of the projection planes, upsizing of the projection display apparatus can be restrained.

In the third aspect, the projection display apparatus includes a protection cover (protection cover 400) provided on an optical path of the image light reflected by the reflection mirror. The protection cover has a transmissive region for transmitting the image light. The transmissive region includes a first transmissive region (transmissive region 480) for transmitting one portion of the image light reflected by the reflection mirror; and a second transmissive region (transmissive region 440) for transmitting another portion of the image light reflected by the reflection mirror. The projection optical unit configured to project, on a first projection plane (projection plane 210), the one portion of the image light transmitted through the first transmissive region, and to project, on a second projection plane (projection plane 220), the another portion of the image light transmitted through the second transmissive region.

In the third aspect, the half mirror is the second transmissive region.

In the third aspect, the reflection mirror focuses the one portion of the image light emitted from the image light generating unit between the half mirror and the first projection plane. The first transmissive region is disposed in proximity to a position at which the image light is focused.

In the third aspect, the reflection mirror focuses the another portion of the image light emitted from the image light generating unit between the half mirror and the second projection plane. The second transmissive region is disposed in proximity to a position at which the image light is focused.

In the third aspect, the reflection mirror focuses the image light emitted from the image light generating unit between the half mirror and the second projection plane. The half mirror is disposed in proximity to a position at which the image light is focused.

In the third aspect, the protection cover has opening communicating from the reflection mirror to the projection plane. The transmissive region is the opening.

In the third aspect, at least part of the protection cover is comprised of a light-transmissive member. The transmissive region is comprised of the light-transmissive member.

A forth aspect of a projection display apparatus, includes: an image light generating unit (image light generating unit 200) having display element (display element 40) configured to generate image light; and a projection optical unit (projection optical unit 300) configured to project the image light on a projection plane. The projection optical unit has a reflection mirror (reflection mirror 320) configured to reflect the image light emitted from the image light generating unit. The reflection mirror focuses the image light emitted from the image light generating unit. The display element has a first display region (display region 45) and a second display region (display region 46). The reflection mirror has a first reflective region (first reflective region 321) and a second reflective region (second reflective region). The first reflective region reflects a first image light emitted from the first display region and focuses the first image light emitted from the first display region. The second reflective region reflects a second image light emitted from the second display region and focuses the second image light emitted from the second display region.

According to the forth aspect, the display element has the first display region and the second display region, and the reflection mirror has the first reflective region and the second reflective region. Therefore, images can be displayed at two sites by means of one projection display apparatus.

Further, the first reflective region focuses the first image light emitted from the first display region. The second reflective region focuses the second image light emitted from the second display region. Therefore, upsizing of the projection display apparatus can be restrained.

In this manner, in a case in which images are displayed on a plurality of projection planes, even where an attempt is made to reduce a distance between the projection display apparatus and each of the projection planes, upsizing of the projection display apparatus can be restrained.

Further, the display element has the first display region for emitting the first image light and the second display region for emitting the second image light. Therefore, different images can be displayed on the plurality of projection planes.

In the forth aspect, the projection display apparatus includes a protection cover (protection cover 400) provided on an optical path of the image light reflected by the reflection mirror. The protection cover has a transmissive region for transmitting the image light. The transmissive region includes a first transmissive region (transmissive region 430) for transmitting the first image light reflected by the first reflective region; and a second transmissive region (transmissive region 440) for transmitting the second image light reflected by the second reflective region. The projection optical unit configured to project, on a first projection plane, the first image light transmitted through the first transmissive region, and to project, on a second projection plane, the second image light transmitted through the second transmissive region.

In the forth aspect, the projection optical unit has a first half mirror (first half mirror 351) provided on the optical path of the first image light reflected by the first reflective region. The first transmissive region includes a first transmissive region (a) and a first transmissive region (b). The first half mirror reflects one portion of the first image light to the first transmissive region (a) side, and transmits the another portion of the first image light to the first transmissive region (b) side.

In the forth aspect, the projection optical unit has a second half mirror (second half mirror 352) provided on the optical path of the second image light reflected by the second reflective region. The second transmissive region includes a second transmissive region (a) and a second transmissive region (b). The second half mirror reflects one portion of the second image light to the second transmissive region (a) side, and transmits the another portion of the second image light to the second transmissive region (b) side.

In the forth aspect, the first reflective region focuses the first image light emitted from the first display region between the first reflective region and the first projection plane. The first half mirror is disposed in proximity to a position at which the first image light is focused.

In the forth aspect, the second reflective region focuses the second image light emitted from the second display region between the second reflective region and the second projection plane. The second half mirror is disposed in proximity to a position at which the second image light is focused.

In the forth aspect, the fast reflective region focuses the first image light emitted from the first display region between the first reflective region and the first projection plane. The first transmissive region is disposed in proximity to a position at which the first image light is focused.

In the forth aspect, the second reflective region focuses the second image light emitted from the second display region between the second reflective region and the second projection plane. The second transmissive region is disposed in proximity to a position at which the second image light is focused.

In the forth aspect, the protection cover has opening communicating from the reflection mirror to the projection plane. The transmissive region is the opening.

In the forth aspect, at least part of the protection cover is comprised of a light-transmissive member. The transmissive region is comprised of the light-transmissive member.

A fifth aspect of a projection display apparatus, includes: an image light generating unit (image light generating unit 200) having display element (display element 40) configured to generate image light; and a projection optical unit (projection optical unit 300) configured to project the image light on a projection plane. The projection display apparatus includes a polarization adjusting element (polarization adjusting element 60) provided on the optical path of the image light emitted from the display element. The projection optical unit has a reflection mirror (reflection mirror 320) configured to reflect the image light emitted from the display element, and a reflective polarization plate (reflective polarization plate 360) provided on the optical path of the image light reflected by the reflection mirror. The reflection mirror focuses the image light emitted from the image light generating unit. The display element displays a first image and a second image in time division. The polarization adjusting element adjusts first image light which corresponds to the first image, into first polarization, and adjusts second image light which corresponds to the second image, into second polarization, of the image light emitted from the display element. The reflective polarization plate reflects the first image light adjusted into the first polarization, and transmits the second image light adjusted into the second polarization.

According to the fifth aspect, the polarization adjusting element adjusts the first image light into the first polarization and adjusts the second image light into the second polarization. The reflective polarization plate reflects the first image light adjusted into the first polarization. On the other hand, the reflective polarization plate transmits the second image light adjusted into the second polarization. Therefore, images can be displayed at two sites by means of one projection display apparatus.

In addition, the reflection mirror focuses the image light emitted from the image light generating unit. Therefore, upsizing of the projection display apparatus can be restrained.

In this manner, in a case in which images are displayed on a plurality of projection planes, even where an attempt is made to reduce a distance between the projection display apparatus and each of the projection planes, upsizing of the projection display apparatus can be restrained.

Further, the display element displays the first image and the second image in time division. Therefore, different images can be displayed on the plurality of projection planes.

In the fifth aspect, the projection display apparatus includes a protection cover (protection cover 400) provided on an optical path of the image light reflected by the reflection mirror. The protection cover has a transmissive region for transmitting the image light. The transmissive region includes a first transmissive region (transmissive region 430) for transmitting the first image light adjusted into the first polarization; and a second transmissive region (transmissive region 440) for transmitting the second image light adjusted into the second polarization. The projection optical unit configured to project, on a first projection plane, the first image light transmitted through the first transmissive region, and to project, on a second projection plane, the second image light transmitted through the second transmissive region.

In the fifth aspect, the reflective polarization plate is the second transmissive region.

In the fifth aspect, the reflection mirror focuses the first image light emitted from the image light generating unit between the reflective polarization plate and the first projection plane. The first transmissive region is disposed in proximity to a position at which the first image light is focused.

In the fifth aspect, the reflection mirror focuses the second image light emitted from the image light generating unit between the reflective polarization plate and the second projection plane. The second transmissive region is disposed in proximity to a position at which the second image light is focused.

In the fifth aspect, the reflection mirror focuses the image light emitted from the image light generating unit between the reflective polarization plate and the second projection plane. The reflective polarization plate is disposed in proximity to a position at which the image light is focused.

In the fifth aspect, the protection cover has opening communicating from the reflection mirror to the projection plane. The transmissive region is the opening.

In the fifth aspect, at least part of the protection cover is comprised of a light-transmissive member. The transmissive region is comprised of the light-transmissive member.

### BRIEF DESCRIPTION OF THE DRAWINGS

FIG. 1 is a view showing a projection display apparatus 100 according to a first embodiment.

FIG. 2 is a view showing the projection display apparatus 100 according to the first embodiment.

FIG. 3(A) and FIG. 3(B) are views showing a support mechanism 500 according to the first embodiment.

FIG. 4(A) and FIG. 4(B) are views showing the support mechanism 500 according to the first embodiment.

FIG. 5 is a view showing a configuration of an image light generating unit 200 according to the first embodiment.

FIG. 6 is a view showing a projection display apparatus 100 according to a second embodiment.

FIG. 7 is a view showing the projection display apparatus 100 according to the second embodiment.

FIG. 8(A) and FIG. 8(B) are views showing a support mechanism 500 according to the second embodiment.

FIG. 9(A) and FIG. 9(B) are views showing the support mechanism 500 according to the second embodiment.

FIG. 10 is a view showing a projection display apparatus 100 according to a third embodiment.

FIG. 11 is a view showing the projection display apparatus 100 according to the third embodiment.

FIG. 12(A) and FIG. 12(B) are views showing a support mechanism 500 according to the third embodiment.

FIG. 13(A) and FIG. 13(B) are views showing the support mechanism 500 according to the third embodiment.

FIG. 14 is a view showing a projection display apparatus 100 according to a fourth embodiment.

FIG. 15 is a view showing the projection display apparatus 100 according to the fourth embodiment.

FIG. 16(A) and FIG. 16(B) are views showing a first opening portion 410 and a second opening portion 420, according to the fourth embodiment.

FIG. 17(A) and FIG. 17(B) are views showing the first opening portion 410 and the second opening portion 420, according to the fourth embodiment.

FIG. 18 is a view showing a support mechanism 500 and an open/close mechanism 600, according to a fifth embodiment.

FIG. 19 is a view showing the support mechanism 500 and the open/close mechanism 600, according to the fifth embodiment.

FIG. 20 is a block diagram depicting a control unit 250 according to a sixth embodiment.

FIG. 21 is a view showing a projection display apparatus 100 according to a seventh embodiment.

FIG. 22 is a view showing a display example according to the seventh embodiment.

FIG. 23 is a view showing the display example according to the seventh embodiment.

FIG. 24 is a view showing a setup example according to the seventh embodiment.

FIG. 25 is a view showing the setup example according to the seventh embodiment.

FIG. 26 is a view showing a projection display apparatus 100 according to an exemplary modification of the seventh embodiment.

FIG. 27 is a view showing the projection display apparatus 100 according to an eighth embodiment.

FIG. 28 is a view showing a display example according to the eighth embodiment.

FIG. 29 is a view showing a projection display apparatus 100 according to a ninth embodiment.

FIG. 30 is a view showing a display example according to the ninth embodiment.

FIG. 31 is a view showing the display example according to the ninth embodiment.

FIG. 32 is a view showing a projection display apparatus 100 according to a tenth embodiment.

FIG. 33 is a view showing a display example according to the tenth embodiment.

FIG. 34 is a view showing the display example according to the tenth embodiment.

FIG. 35 is a view showing a setup example according to the tenth embodiment.

FIG. 36 is a view showing the setup example according to the tenth embodiment.

FIG. 37 is a view showing a projection display apparatus 100 according to an exemplary modification of the tenth embodiment.

FIG. 38 is a view showing a projection display apparatus 100 according to an eleventh embodiment.

FIG. 39 is a view showing a display example according to the eleventh embodiment.

FIG. 40 is a view showing a projection display apparatus 100 according to a twelfth embodiment.

FIG. 41 is a view showing a configuration of an image light generating unit 200 according to the twelfth embodiment.

FIG. 42 is a view showing a reflective polarization plate 360 according to the twelfth embodiment.

FIG. 43(A) and FIG. 43(B) are views showing a polarization adjusting element 60 according to the twelfth embodiment.

FIG. 44 is a view showing a display example according to the twelfth embodiment.

FIG. 45 is a view showing the display example according to the twelfth embodiment.

FIG. 46 is a view showing a setup example according to the twelfth embodiment.

FIG. 47 is a view showing the setup example according to the twelfth embodiment.

FIG. 48 is a view showing a projection display apparatus 100 according to an exemplary modification of the twelfth embodiment.

FIG. 49 is a view showing a projection display apparatus 100 according to a thirteenth embodiment.

FIG. 50 is a view showing a display example according to the thirteenth embodiment.

FIG. 51 is a view showing a projection display apparatus 100 according to a fourteenth embodiment.

FIG. 52 is a view showing a display example according to the fourteenth embodiment.

FIG. 53 is a view showing the display example according to the fourteenth embodiment.

### BEST MODE FOR CARRYING OUT THE INVENTION

Hereinafter, a projection display apparatus according to the embodiments of the present invention will be described with reference to the drawings. In the following description of the drawings, the same or similar reference signs are attached to the same or similar units and portions.

It should be noted that the drawings are schematic and ratios of dimensions and the like are different from actual ones. Therefore, specific dimensions and the like should be determined in consideration of the following description. Moreover, as a matter of course, the drawings also include portions having different dimensional relationships and ratios from each other.

### First Embodiment

### Configuration of Projection Display Apparatus

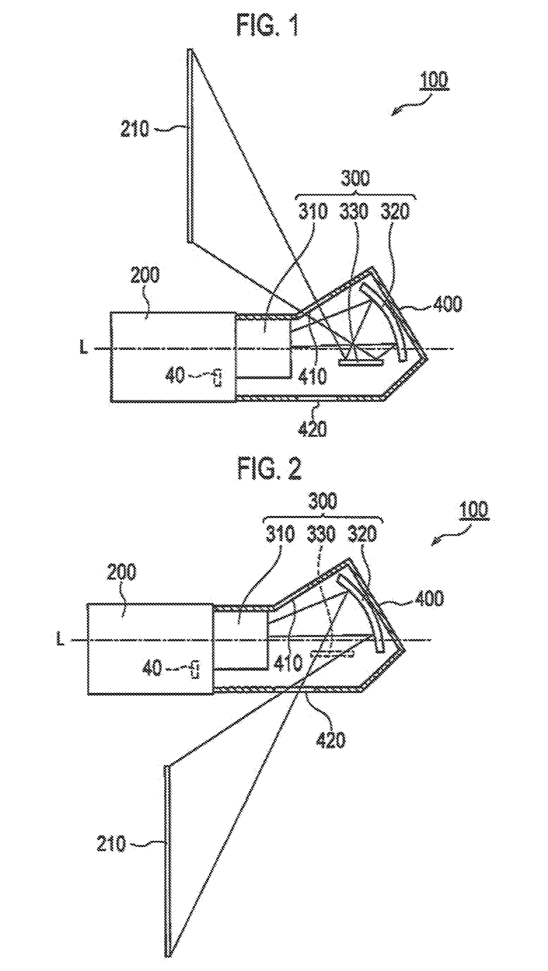

Hereinafter, a configuration of a projection display apparatus according to a first embodiment will be described with reference to the drawings. FIG. 1 and FIG. 2 are views showing a configuration of a projection display apparatus 100 according to the first embodiment. FIG. 1 shows an example of floor-placed setup, and FIG. 2 shows an example of ceiling-suspended setup.

As shown in FIG. 1 and FIG. 2, a projection display apparatus 100 has an image light generating unit 200, a projection optical unit 300, and a protection cover 400.

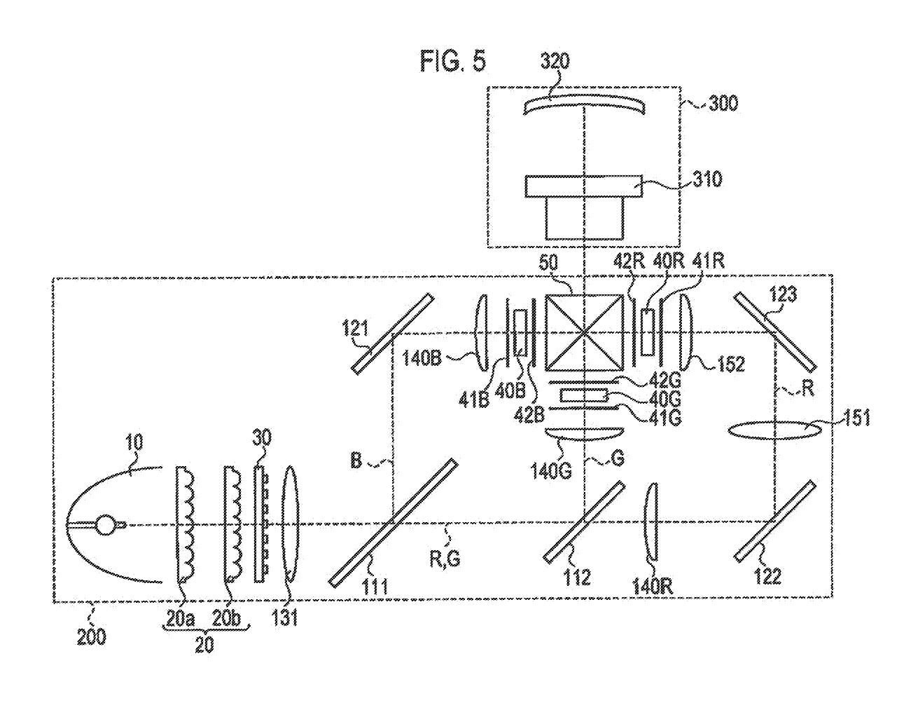

The image light generating unit 200 generates image light. Specifically, the image light generating unit 200 has at least a display element 40 for emitting image light. The display element 40 is provided at a position which is shifted relative to an optical axis L of the projection optical unit 300. The display element 40 is a reflective liquid crystal panel, a transmissive liquid crystal panel, a DMD (Digital Micromirror Device) or the like, for example. A detailed description of the image light generating unit 200 will be given later (see FIG. 5).

The projection optical unit 300 projects image light emitted from the image light generating unit 200. Here, the projection optical unit 300 projects the image light on a projection plane 210. Specifically, the projection optical unit 300 has a projection lens 310, a reflection mirror 320, and a reflection optical element 330.

The projection lens 310 emits the image light emitted from the image light generating unit 200 to the side of the reflection mirror 320.

The reflection mirror 320 reflects the image light emitted from the projection lens 310. The reflection mirror 320 widely angles the image light after focusing the image light. For example, the reflection mirror 320 is a non-spherical mirror having a concave face on the side of the image light generating unit 200.

The reflection optical element 330 is a reflection mirror for reflecting the image light reflected by the reflection mirror 320. As states of the reflection optical element 330, there can be considered a state shown in FIG. 1 (hereinafter, referred to as a first state) and a state shown in FIG. 2 (hereinafter, referred to as a second state).

The first state is a state in which the reflection optical element 330 is disposed on an optical path of the image light reflected by the reflection mirror 320. That is, in the first state, as shown in FIG. 1, the reflection optical element 330 is mounted on an optical path of the image light reflected by the reflection mirror 320.

On the other hand, the second state is a state in which the reflection optical element 330 is caused to come off from the course of the optical path of the image light reflected by the reflection mirror 320. That is, in the second state, as shown in FIG. 2, the reflection optical element 330 is caused to come off from the course of the optical path of the image light reflected by the reflection mirror 320.

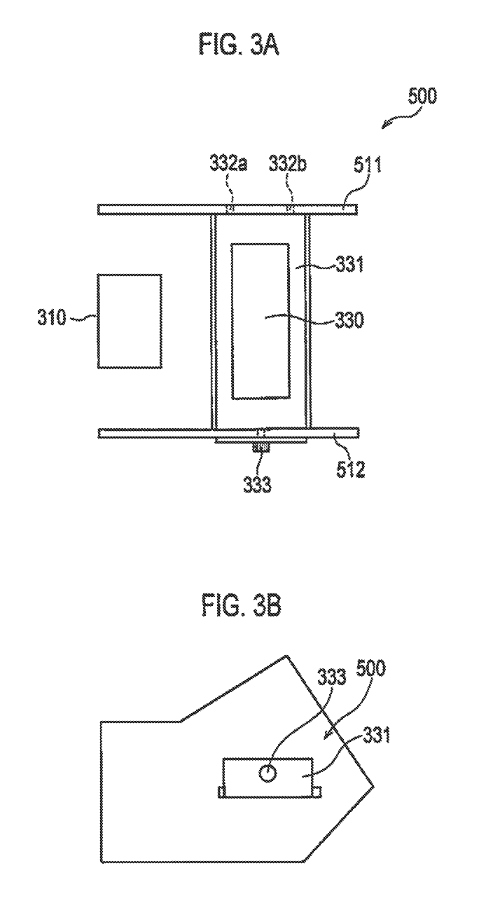

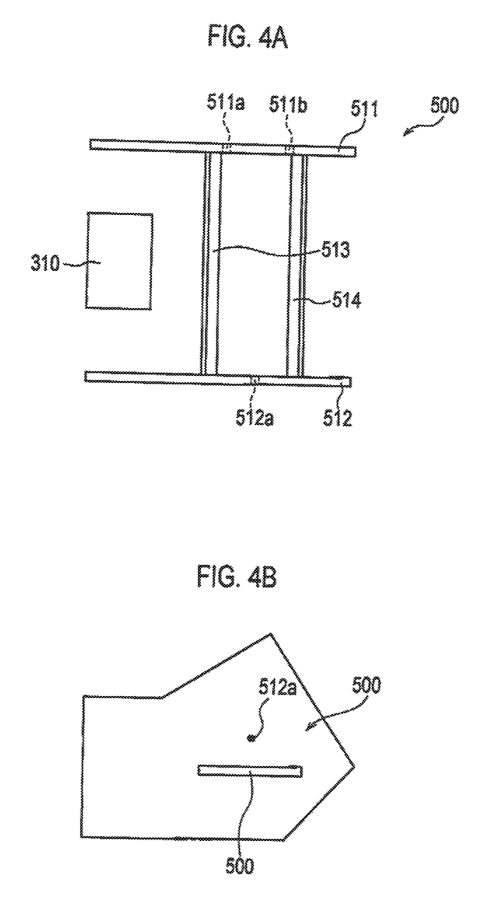

In the first embodiment, the reflection optical element 330 is removably configured. Although not shown in FIG. 1 and FIG. 2, the projection display apparatus 100 has a support mechanism (support mechanism 500 to be described later) supporting the reflection optical element 330 while the first and second states can be switched from each other. A detailed description of the support mechanism will be given later (see FIG. 3(A), FIG. 3(B), FIG. 4(A) and FIG. 4(B)).

The protection cover 400 is a cover for protecting the reflection mirror 320. The protection cover 400 is provided on the =optical path of the image light reflected by the reflection mirror 320. Specifically, the protection cover 400, as shown in FIG. 1, has a first opening portion 410 for transmitting the image light reflected by the reflection optical element 330, in the first state. The protection cover 400, as shown in FIG. 2, has a second opening portion 420 for transmitting the image light reflected by the reflection mirror 320, in the second state. In the first embodiment, the first opening portion 410 is provided on a side face of the protection cover 400 opposite to the second opening portion 420.

In this manner, the projection optical unit 300 projects the image light transmitting the first opening portion 410, on the projection plane 210, in the first state. The projection optical unit 300 projects the image light transmitting the second opening portion 420, on the projection plane 210, in the second state.

(Configuration of Support Mechanism)

Hereinafter a configuration of a support mechanism according to the first embodiment will be described with reference to the drawings. FIG. 3(A) and FIG. 3(B) are views showing a support mechanism 500 according to the first embodiment (first state). FIG. 4(A) and FIG. 4(B) are other views showing the support mechanism 500 according to the first embodiment (second state).

In the first embodiment, as described above, the reflection optical element 330 is removably configured. That is, the support mechanism 500 removably supports the reflection optical element 330.

As shown in FIG. 3(A), the reflection optical element 330 is mounted to a base 331. The base 331 has a pair of guide pins (guide pin 332a and guide pin 332b) and a fixing screw 333.

As shown in FIG. 4(A), the support mechanism 500 has: a pair of outer frames (outer frame 511 and outer frame 512), which are compatible with outer frames of the protection cover 400; and a pair of arm members (arm member 513 and arm member 514). The outer frame 511 has a guide groove 511a into which a guide pin 332a is to be inserted and a guide groove 511b into which a guide pin 332b is to be inserted. The outer frame 512 has a screw hole 512a into which a fixing screw 333 is to be turned. The arm member 513 and the arm member 514 define a position of the base 331 and support the base 331.

As shown in FIG. 3(A) and FIG. 3(B), in the first state, the base 331 to which the reflection optical element 330 is mounted is further mounted to the support mechanism 500. Specifically, the guide pin 332a and the guide pin 332b that are provided at the base 331 are firstly inserted into the guide groove 511a and the guide groove 511b that are provided at the support mechanism 500, respectively. The fixing screw 333 that is provided at the base 331 is secondly turned into a screw hole 512a which is provided at the support mechanism 500.

As shown in FIG. 4(A) and FIG. 4(B), in the second state, the base 331 to which the reflection optical element 330 is mounted is removed from the support mechanism 500.

It is preferable that the support mechanism 500 is integrated with the protection cover 400. That is, it is preferable that the protection cover 400 has the support mechanism 500.

(Configuration of Image Light Generating Unit)

Hereinafter, a configuration of the image light generating unit according to the first embodiment will be described with reference to the drawings. FIG. 5 is a view mainly showing an image light generating unit 200 according to the first embodiment. The image light generating unit 200 has a power circuit (not shown), an image signal processing circuit (not shown) or the like in addition to the constituent elements shown in FIG. 5. Here is illustrated a case in which the display element 40 is a transmissive light crystal panel.

The image light generating unit 200 has a light source 10, a fly-eye lens unit 20, a Polarizing Beam Splitter (PBS) array 30, a plurality of liquid crystal panels 40 (liquid crystal panel 40R, liquid crystal panel 40G, liquid crystal panel 40B), and a cross-dichroic prism 50.

The light source 10 is a UHP lamp or the like comprised of a burner and a reflector. The light emitted from the light source 10 includes red component light, green component light, and blue component light.

The fly-eye lens unit 20 uniformizes the light emitted from the light source 10. Specifically, the fly-eye lens unit 20 is comprised of a fly-eye lens 20a and a fly-eye lens 20b.

The fly-eye lens 20a and the fly-eye lens 20b are comprised of a plurality of micro-lenses, respectively. Each micro-lens focuses the light emitted from the light source 10 so that the light emitted from the light source 10 is irradiated all over the liquid crystal panel 40.

The PBS array 30 coordinates a polarization state of the light emitted from the fly-eye lens unit 20. In the first embodiment, the PBS array 30 coordinates the light emitted from the fly-eye lens 20 with P-polarization.

The liquid crystal panel 40R modulates red component light by rotating the polarization direction of the red component light. An incidence-side polarization plate 41R for transmitting the light having one polarization direction (for example, P-polarization) and interrupting the light having the other polarization direction (for example, S-polarization) is provided on the light-incidence plane side of the liquid crystal panel 40R. An emission-side polarization plate 42R for interrupting the light having one polarization direction (for example, P-polarization) and transmitting the light having the other polarization direction for example, S-polarization) is provided on the light-emission plane side of the liquid crystal panel 40R.

Similarly, the liquid crystal panel 40G and the liquid crystal panel 40B modulate green component light and blue component light by rotating the polarization direction of the green component light and the blue component light, respectively. The incidence-side polarization plate 41G is provided on the light-incidence plate side of the liquid crystal panel 40G and an emission-side polarization plate 42G is provided on the light-emission plane side of the liquid crystal panel 40G. An incidence-side polarization plate 41B is provided on the light-incidence plane side of the liquid crystal panel 40B and an emission-side polarization plate 42B is provided on the light-emission plane side of the liquid crystal panel 40B.

The cross-dichroic prism 50 combines the light emitted from the liquid crystal panel 40R, the liquid crystal panel 40G, and the liquid crystal panel 40B with each other. The cross-dichroic prism 50 emits the combined light to the side of the projection lens 310.

In addition, the image light generating unit 200 has: a mirror group (dichroic mirror 111, dichroic mirror 112, reflection mirror 121 to reflection mirror 123); and a lens group (condenser lens 131, condenser lens 140R, condenser lens 140G, condenser lens 140B, relay lens 151 and relay lens 152).

The dichroic mirror 111 transmits red component light and green component light of the light emitted from the PBS array 30. The dichroic mirror 111 reflects blue component light of the light emitted from the PBS array 30.

The dichroic mirror 112 transmits red component light of the light transmitting the dichroic mirror 111. The dichroic mirror 112 reflects green component light of the light transmitting the dichroic mirror 111.

The reflection mirror 112 reflects blue component light and guides the reflected light to the side of the liquid crystal panel 40B. The reflection mirror 122 and the reflection mirror 123 reflect red component light, and guide the reflected light to the side of the liquid crystal panel 40R.

The condenser lens 131 is a lens for focusing incandescent light emitted from the light source 10.

The condenser lens 140R substantially collimates red component light so that the liquid crystal panel 40R is irradiated with the red component light. The condenser lens 140G substantially collimates green component light so that the liquid crystal panel 40G is irradiated with the green component light. The condenser lens 140B substantially collimates blue component light so that the liquid crystal panel 40B is irradiated with the blue component light.

The relay lens 151 and the relay lens 152 substantially form an image with red component light on the liquid crystal panel 40R while restraining expansion of the red component light.

(Function(s) and Effect(s))

In the first embodiment, the support mechanism 500 supports a reflection optical element 330 while the first state and the second state can be switched from each other. The projection optical unit 300 projects the image light reflected by the reflection optical element 330, in the first state, and projects the image light reflected by the reflection mirror 320, in the second state.

In this manner, floor-placed setup and ceiling-suspended setup can be switched from each other without inverting the top and bottom of the projection display apparatus 100. That is, the disposition precision of the reflection mirror 320 can be appropriately maintained, since the direction of gravity applied to the reflection mirror 320 provided to reduce a distance between the projection display apparatus 110 and the projection plane is not reversed.

In the first embodiment, the protection cover 400 is provided on the optical path of the image light reflected by the reflection mirror 320. Therefore, an angle or the like of the reflection mirror 320 can be restrained from being varied by a user touching the reflection mirror 320. In addition, the protection cover 400 has opening portions (first opening portion 410 and second opening portion 420) for transmitting the image light reflected by the reflection mirror 320. Accordingly, the image light with which the projection plane 210 is irradiated is never interrupted by the protection cover 400. In this manner, the disposition precision of the reflection mirror 320 provided to reduce a distance between the projection display apparatus 100 and the projection plane can be appropriately maintained.

### Second Embodiment

Hereinafter, a second embodiment will be described with reference to the drawings. Hereinafter, differences between the first embodiment and the second embodiment will be mainly described.

Specifically, in the first embodiment, a reflection optical element 330 is removably configured. In contrast, in the second embodiment, reflection optical element 330 is turnably configured.

(Configuration of Projection Display Apparatus)

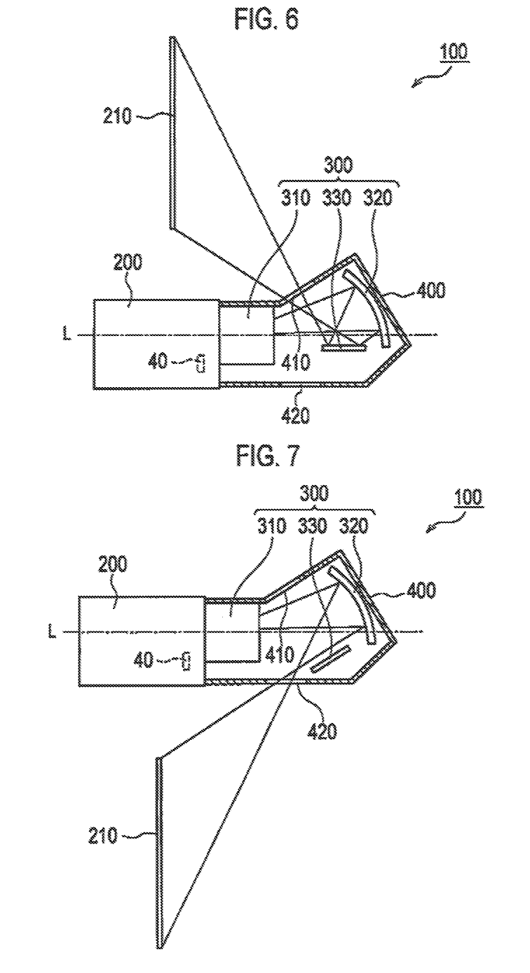

Hereinafter, a configuration of a projection display apparatus according to the second embodiment will be described with reference to the drawings. FIG. 6 and FIG. 7 are views showing a configuration of a projection display apparatus 100 according to the second embodiment. FIG. 6 shows an example of floor-placed setup and FIG. 7 shows an example of ceiling-suspended setup. In FIG. 6 and FIG. 7, like constituent elements shown in FIG. 1 and FIG. 2 are designated by like reference numerals.

A first state, like the first embodiment, is a state in which the reflection optical element 330 is disposed on an optical path of image light reflected by a reflection mirror 320. That is, in the first state, as shown in FIG. 6, the reflection optical element 330 turns on the optical path of the image light reflected by the reflection mirror 320.

On the other hand, a second state, like the first embodiment, is a state in which the reflection optical element 330 is caused to come off the course of the optical path of the image light reflected by the reflection mirror 320. That is, in the second state, as shown in FIG. 7, the reflection optical element 330 turns so as to come off from the course of the optical path of the image light reflected by the reflection mirror 320.

(Configuration of Support Mechanism)

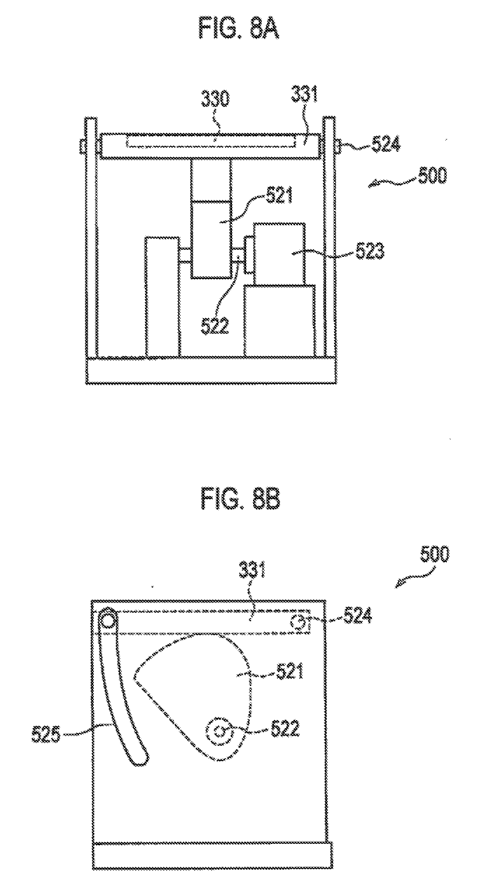

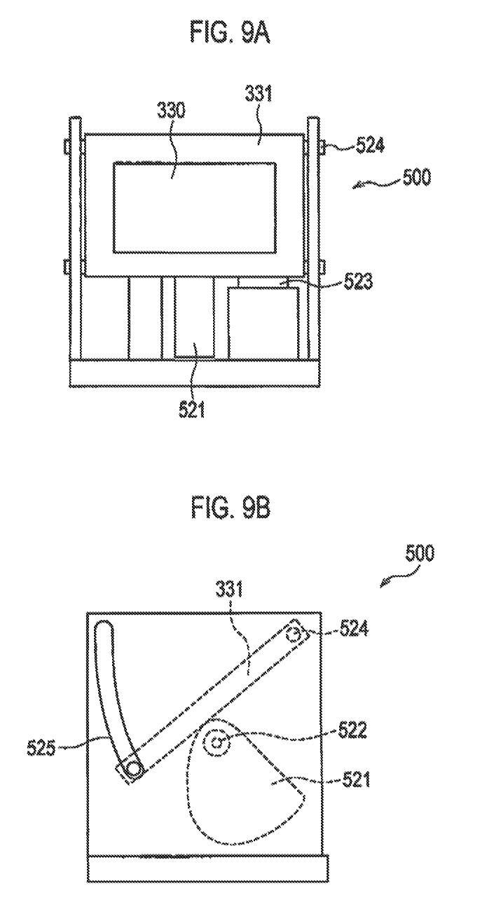

Hereinafter, a configuration of a support mechanism according to the second embodiment will be described with reference to the drawings. FIG. 8(A) and FIG. 8(B) are views showing a support mechanism 500 according to the second embodiment (first state). FIG. 9(A) and FIG. 9(B) are other views showing the support mechanism 500 according to the second embodiment (second state).

In the second embodiment, as described above, the reflection optical element 330 is turnably configured. That is, the support mechanism 500 turnably supports the reflection optical element 330.

As shown in FIG. 8(A) and FIG. 9(A), the reflection optical element 330 is mounted to a base 331. The base 331 is mounted to a turn shaft 524 which is provided at the support mechanism 500.

As shown in FIG. 8(A), FIG. 8(B), FIG. 9(A), and FIG. 9(B), the support mechanism 500 has an eccentric cam 521, a cam shaft 522, a motor mechanism 523, a turn shaft 524, and a guide mechanism 525.

The eccentric cam 521 turns around the cam shaft 522. The eccentric cam 521 supports the base 331 to which the reflection optical element 330 is mounted. The cam shaft 522 turns owing to the drive force generated by the motor mechanism 523. The cam shaft 522 is provided at a position coming off from the center of the eccentric cam 521. The turn shaft 524 turnably supports the base 331 to which the reflection optical element 330 is mounted. The guide groove 525 is a groove taken along an arc drawn by the base 331 turning around the turn shaft 524. The guide groove 525 aids in turning of the base 331 to which the reflection optical element 330 is mounted.

In this manner, owing to the drive force generated by the motor mechanism 523, the base 331 to which the reflection optical element 330 is mounted turns along the guide groove 525 around the turn shaft 524. The guide groove 525 may specify a turn range of the base 331.

As shown in FIG. 8(A) and FIG. 8(B), in the first state, the base 331 to which the reflection optical element 330 is mounted turns on the optical path of the image light reflected by the reflection mirror 320, owing to the rotation of the cam shaft 522. On the other hand, as shown in FIG. 9(A) and FIG. 9(B), in the second state, the base 331 to which the reflection optical element 330 is mounted turns so as to come off from the course of the optical path of the image light reflected by the reflection mirror 320, owing to the rotation of the cam shaft 522.

### Third Embodiment

Hereinafter, a third embodiment will be described with reference to the drawings. Hereinafter, differences between the first embodiment and the third embodiment will be mainly described.

Specifically, in the first embodiment, the reflection optical element 330 is removably configured. On the other hand, in the third embodiment, the reflection optical element 330 is slidably configured.

(Configuration of Projection Display Apparatus)

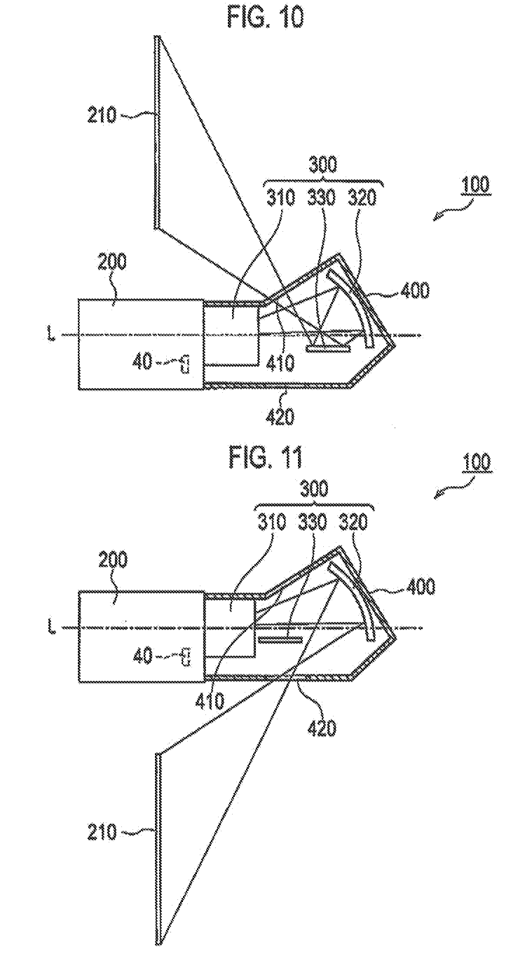

Hereinafter, a configuration of a projection display apparatus according to the third embodiment will be described with reference to the drawings. FIG. 10 and FIG. 11 are views showing a configuration of the projection display apparatus 100 according to the third embodiment. FIG. 10 shows an example of floor-placed setup, and FIG. 11 shows an example of ceiling-suspended setup. In FIG. 10 and FIG. 11, like constituent elements shown in FIG. 1 and FIG. 2 are designated by like reference numerals.

A first state, like the first embodiment, is a state in which the reflection optical element 330 is disposed on an optical path of image light reflected by the reflection mirror 320. That is, in the first state, as shown in FIG. 10, the reflection optical element 330 slides on the optical path of the image light reflected by the reflection mirror 320.

On the other hand, a second state, like the first embodiment, is a state in which the reflection optical element 330 is caused to come off from the course of the optical path of the image light reflected by the reflection mirror 320. That is, in the second state, as shown in FIG. 11, the reflection optical element 330 slides so as to come off from the course of the optical path of the image light reflected by the reflection mirror 320.

(Configuration of Support Mechanism)

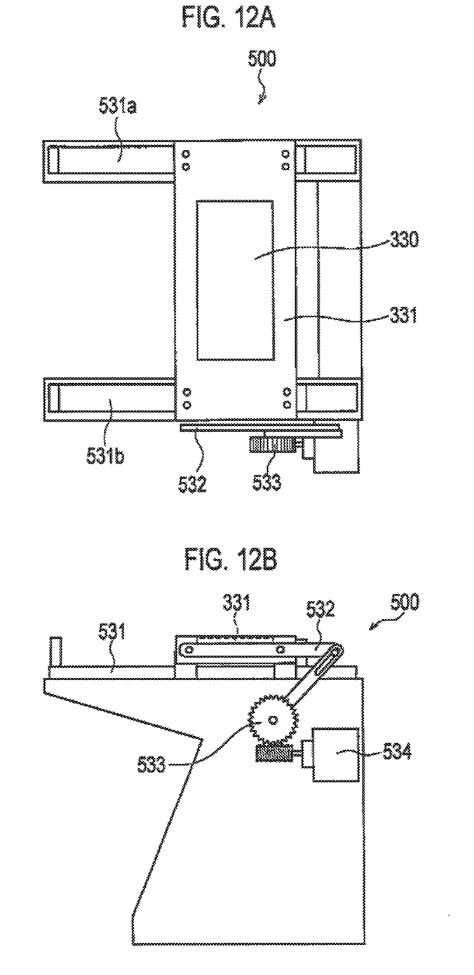

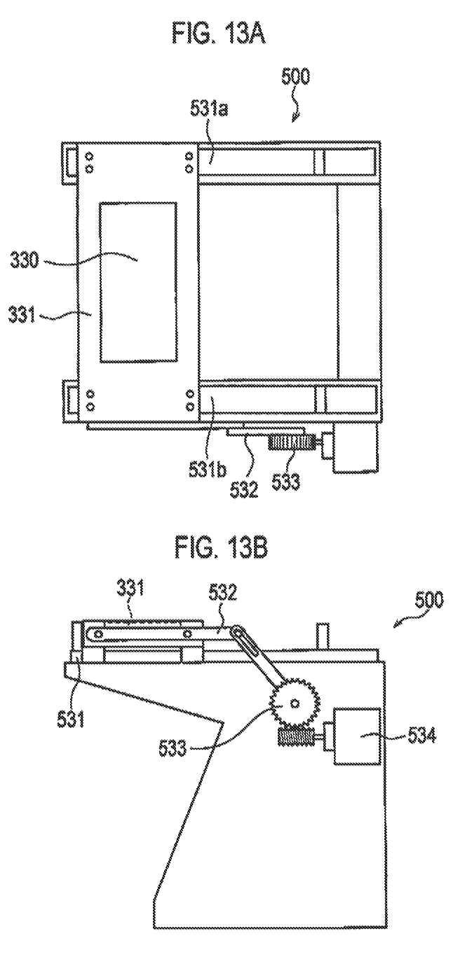

Hereinafter, a configuration of a support mechanism according to a third embodiment will be described with reference to the drawings. FIG. 12(A) and FIG. 12(B) are views showing a support mechanism 500 according to the third embodiment (first state). FIG. 13(A) and FIG. 13(B) are other views showing the support mechanism 500 according to the third embodiment (second state).

In the third embodiment, as described above, the reflection optical element 330 is slidably configured. That is, the support mechanism 500 slidably supports the reflection optical element 330.

As shown in FIG. 12(A) and FIG. 13(B), the reflection optical element 330 is mounted to a base 331. The base 331 is fixed to an arm member 532 which is provided at the support mechanism 500.

As shown in FIG. 12(A), FIG. 12(B), FIG. 13(A), and FIG. 13(B), the support mechanism 500 has a pair of guide rails 531 (guide ran 531a and guide rail 531b), an arm member 532, a gear 533, and a motor mechanism 534.

The guide rail 531 is a rail for slidably supporting the arm member 532. The gear 533 rotates owing to the drive force generated by the motor mechanism 534. That is, the base 331 fixed to the arm member 532 slides on the guide rail 531, owing to the drive force generated by the motor mechanism 534.

(As shown in FIG. 12(A) and FIG. 12(B), in the first state, the base 331 to which the reflection optical element 330 is mounted slides on the optical path of the image light reflected by the reflection mirror 320, owing to the rotation of the gear 533. On the other hand, as shown in FIG. 13(A) and FIG. 13(B), in the second state, the base 331 to which the reflection optical element 330 is mounted slides so as to come off from the course of the optical path of the image light reflected by the reflection mirror 320, owing to the rotation of the gear 533.

### Fourth Embodiment

Hereinafter, a fourth embodiment will be described with reference to the drawings. Hereinafter, differences between the first embodiment and the fourth embodiment will be mainly described.

Specifically, in the fourth embodiment, an opening portion is comprised of an opening and a capping member. The fourth embodiment illustrates a case in which the support mechanism 500 shown in the second embodiment is employed.

(Configuration of Projection Display Apparatus)

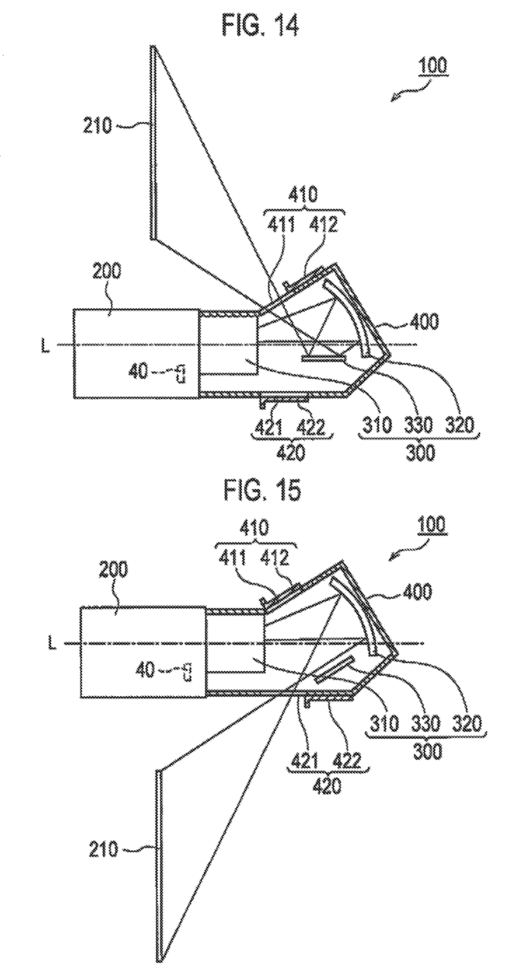

Hereinafter, a configuration of a projection display apparatus according to the fourth embodiment will be described with reference to the drawings. FIG. 14 and FIG. 15 are views showing a configuration of the projection display apparatus 100 according to the fourth embodiment. FIG. 14 shows an example of floor-placed setup, and FIG. 15 shows an example of ceiling-suspended setup. In FIG. 14 and FIG. 15, like constituent elements shown in FIG. 1 and FIG. 2 are designated by like reference numerals.

As shown in FIG. 14 and FIG. 15, a first opening portion 410 has a first opening 411 and a first capping member 412. The first opening 411 transmits image light. The first capping member 412 can close the first opening 411. For example, the first capping member 412 slides, thereby enabling the first opening 411 to be closed by the first capping member 412. Similarly, the first capping member 412 slides thereby enabling the first opening 411 to be exposed therefrom.

A second opening portion 420 has a second opening 421 and a second capping member 422. The second opening 421 transmits image light. The second capping member 422 can close the second opening 421. The second capping member 422 slides thereby enabling the second opening 421 to be dosed by the second capping member 422, for example. Similarly, the second capping member 422 slides thereby enabling the second opening 421 to be exposed therefrom.

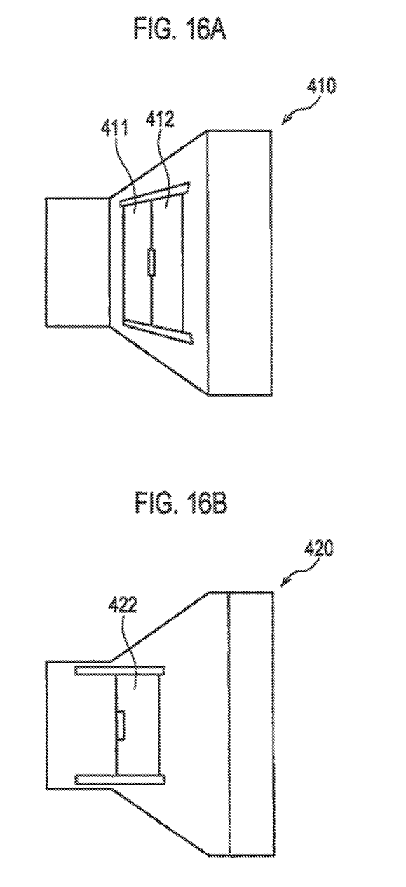

As shown in FIG. 14 and FIG. 16(A), in the first state, the first opening portion 410 allows the first opening 411 to be exposed owing to the slide of the first capping member 412. On the other hand, as shown in FIG. 14 and FIG. 16(B), in the first state, the second opening portion 420 allows the second opening 421 to be closed by the second capping member 422 owing to the slide of the second capping member 422.

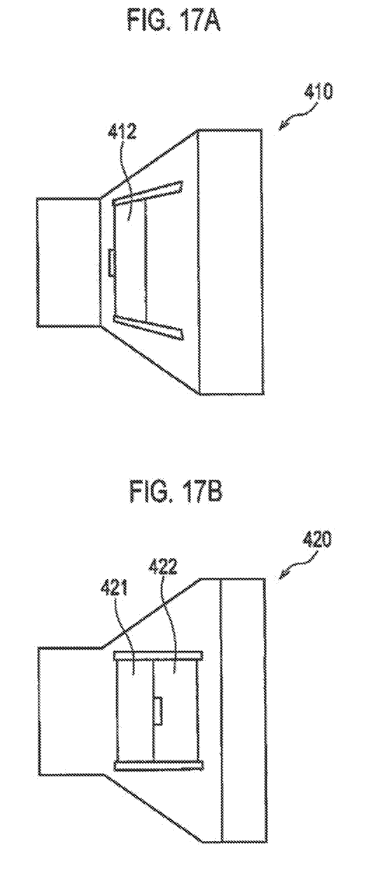

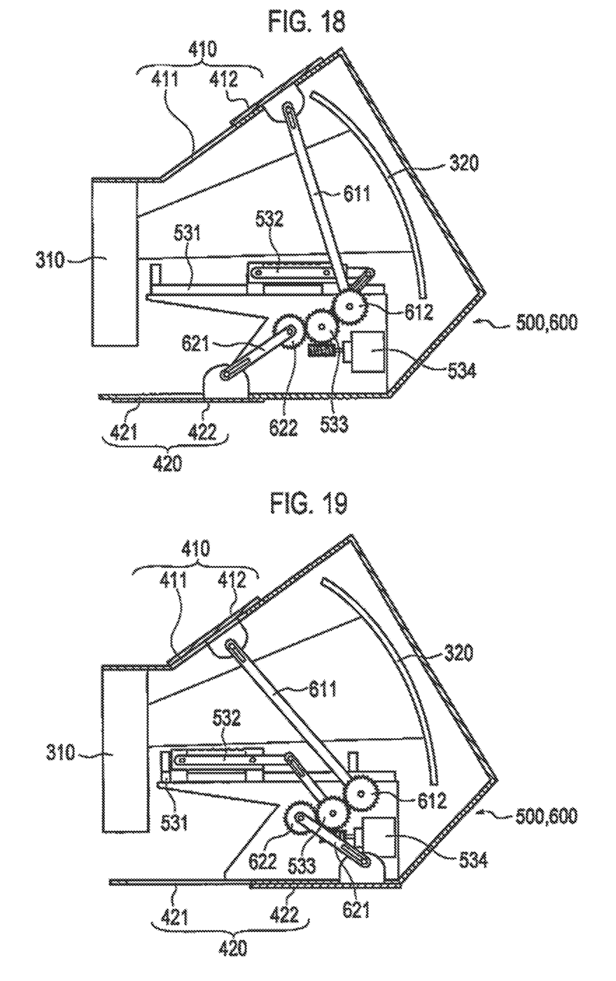

As shown in FIG. 15 and FIG. 17(A), in the second state, the first opening portion 410 allows the first opening 411 to be closed by the first capping member 412 owing to the slide of the first capping member 412. As shown in FIG. 15 and FIG. 17(B), in the second state, the second opening portion 420 allows the second opening 421 to be exposed owing to the slide of the second capping member 422.

(Function(s) and Advantageous Effect(s))

In the fourth embodiment, the first opening portion 410 and the second opening portion 420 have the first capping member 412 and the second capping member 422, respectively. Therefore, an opening which is not employed in projection of image light is closed by a capping member, and the entry of foreign object such as dust and grime into equipment through the opening can be restrained.

### Fifth Embodiment

Hereinafter, a fifth embodiment will be described with reference to the drawings. Hereinafter, differences between the first embodiment and the fifth embodiment will be mainly described.

Specifically, in the fifth embodiment, an opening portion is comprised of an opening and a capping member. The fifth embodiment illustrates a case in which the support mechanism 500 shown in the third embodiment is employed. In addition, the capping member operates in conjunction with the support mechanism 500.

(Operation of Reflection Optical Element and Capping Member)

Hereinafter, operations of a reflection optical element and a capping member according to the fifth embodiment will be described with reference to the drawings. FIG. 18 and FIG. 19 are views for explaining the operations of the reflection optical element and the capping member according to the fifth embodiment. FIG. 18 shows an example of floor-placed setup, and FIG. 19 shows an example of ceiling-suspended setup. In FIG. 18 and FIG. 19, like constituent elements shown in FIG. 12(A), FIG. 12(B), FIG. 13(A) and FIG. 13(B) are designated by like reference numerals.

As shown in FIGS. 18 and 19, a first opening portion 410 has a first opening 411 and a first capping member 412. The first opening 411 transmits image light. The first capping member 412 can close the first opening 411. A second opening portion 420 has a second opening 421 and a second capping member 422. The second opening 421 transmits image light. The second capping member 422 can close the second opening 421.

A projection display apparatus 100 has an open/close mechanism 600 of operating the first capping member 412 that is provided at the first opening portion 410 and the second capping member 422 that is provided at the second opening portion 420.

The open/close mechanism 600 has a first arm member 611, a first gear 612, a second arm member 621, and a second gear 622.

The first arm member 611 is mounted to the first capping member 412 and the first gear 612. The first gear 612 is meshed with a gear 533 and turns in conjunction with the gear 533. The second arm member 621 is mounted to the second capping member 422 and a second gear 622. The second gear 622 is meshed with the gear 533 and turns in conjunction with the gear 533.

As shown in FIG. 18, in a first state, a base 331 to which a reflection optical element 330 is mounted slides on an optical path of image light reflected by a reflection mirror 320, owing to the rotation of the gear 533. In conjunction with this slide, the first capping member 412 slides so as to expose the first opening 411, owing to the turning movement of the gear 533 and the first gear 612. The second capping member 422 slides so as to close the second opening 421, owing to the turning movement of the gear 533 and the second gear 622.

On the other hand, as shown in FIG. 19, in a second state, the base 331 to which the reflection optical element 330 is mounted slides so as to come off from the course of the optical path of the image light reflected by the reflection mirror 320, owing to the rotation of the gear 533. In conjunction with this slide, the first capping member 412 slides so as to close the first opening 411, owing to the turning movement of the gear 533 and the first gear 612. The second capping member 422 slides so as to expose the second opening 412, owing to the turning movement of the gear 533 and the second gear 622.

In this manner, in accordance with a state of the reflection optical element 330, the support mechanism 500 and the open/close mechanism 600 operate in conjunction with each other. That is, the reflection optical element 330, the first capping member 412, and the second capping member 422 appropriately operate in accordance with the state of the reflection optical element 330.

(Function(s) and Advantageous Effect(s))

In the fifth embodiment, the first opening portion 410 and the second opening portion 420 have the first capping member 412 and the second capping member 422, respectively. The open/close mechanism 600 closes an opening, which is not employed in projection of image light, by means of a capping member, in conjunction with the state of the reflection optical element 330. In this manner, the entry of foreign matter such as dust and grime into equipment through the opening can be automatically restrained.

### Sixth Embodiment

Hereinafter, a sixth embodiment will be described with reference to the drawings. Hereinafter, differences between the first embodiment and the sixth embodiment will be mainly described.

Specifically, the sixth embodiment describes a case of controlling constituent elements (for example, liquid crystal panel 40, support mechanism 500, and open/close mechanism 600), in accordance with the state of a reflection optical element 330.

(Function of Projection Display Apparatus)

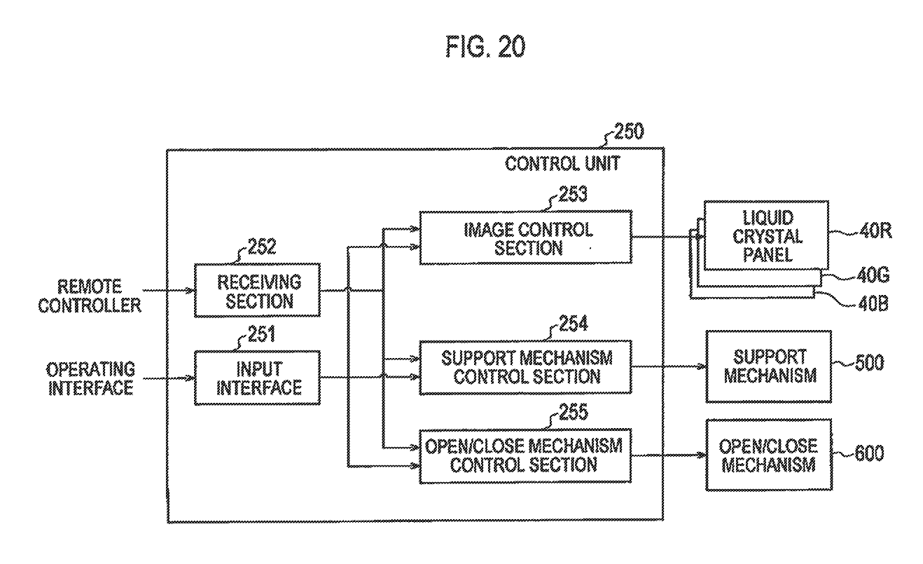

Hereinafter, functions of a projection display apparatus according to the sixth embodiment will be described with reference to the drawings. FIG. 20 is a block diagram depicting a control unit 250 provided in a projection display apparatus 100 according to the sixth embodiment.

As shown in FIG. 20, a control unit 250 has an input interface 251, a receiving section 252, an image control section 253, a support mechanism control section 254, and an open/close mechanism control section 255.

The input interface 251 accepts a variety of information from an operational interface (touch panel or switches) which a user operates. For example, the input interface 251 accepts specific information for specifying a method of setting up the projection display apparatus 100. The items of specific information are information for specifying floor-placed setup and information for specifying ceiling-suspended setup, etc.

The receiving section 252 receives a variety of information from a remote controller for remotely operating the projection display apparatus 100. The receiving section 252 receives specific information for specifying a method of setting up the projection display apparatus 100, for example.

The image control section 253 controls an image displayed on a projection plane 210. That is, the image control section 253 controls a display element 40 (liquid crystal panel 40R to liquid crystal panel 40B).

Specifically, the image control section 253 controls an orientation of the image displayed on the projection plane 210, in accordance with the method of setting up the projection display apparatus 100.

Let us consider a case in which, where the setup method is floor-placed setup, for example, the image control section 253 is set so that the orientation of the image displayed on the projection plane 210 is appropriate. In such a case, where the setup method is ceiling-suspended setup, if image control is not performed in particular, the top and bottom of the image displayed on the projection plane 210 are inverted. Therefore, in a case where the setup method is ceiling-suspended setup, the image control section 253 inverts the top and bottom of the image displayed on the display element 40. That is, in a case where a state of the reflection optical element 330 is the second state, the image control section 253 inverts the top and bottom of the image displayed on the display element 40.

Let us also consider a case in which, where the setup method is ceiling-suspended setup, the image control section 253 is set so that the orientation of the image displayed on the projection plane 210 is appropriate. In such a case, where the setup method is floor-placed setup, if image control is not performed in particular, the top and bottom of the image displayed on the projection plane 210 are inverted. Therefore, in a case where the setup method is floor-placed setup, the image control section 253 inverts the top and bottom of the image displayed on the display element 40. That is, in a case where the state of the reflection optical element 330 is the first state, the image control section 253 inverts the top and bottom of the image displayed on the display element 40.

The support mechanism control section 254 controls a support mechanism 500. Specifically, the support mechanism control section 254 controls the support mechanism 500 in accordance with the setup method of the projection display apparatus 100.

In a case where the setup method is floor-placed setup, for example, the support mechanism control section 254 controls the state of the reflection optical element 330 to enter the first state. That is, the support mechanism control section 254 disposes the reflection optical element 330 on the optical path of the image light reflected by the reflection mirror 320.

On the other hand, in a case where the setup method is ceiling-suspended setup, the support mechanism control section 254 controls the state of the reflection optical element 330 to enter the second state. That is, the support mechanism control section 254 causes the reflection optical element 330 to come off from the course of the optical path of the image light reflected by the reflection mirror 320.

The open/close mechanism control section 255 controls the open/dose mechanism 600. Specifically, the open/close mechanism control section 255 controls the open/close mechanism 600 in accordance with the setup method of the projection display apparatus 100.

In a case where the setup method is floor-placed setup, for example, the open/close mechanism control section 255 operates a first capping member 412 so as to expose a first opening 411 and operates a capping member 422 so as to dose a second opening 421. That is, the open/close mechanism control section 255 exposes the first opening 411 and closes the second opening 421, in the first state.

On the other hand, in a case where the setup method is ceiling-suspended setup, the open/close mechanism control section 255 operates a first capping member 412 so as to close the first opening 411 and operates the second capping member 422 so as to expose the second opening 421. That is, the open/dose mechanism control section 255 closes the first opening 411 and exposes the second opening 421, in the second state.

As shown in the fifth embodiment, in a case where the support mechanism 500 and the open/close mechanism 600 move in conjunction with each other, the support mechanism control section 254 and the open/close mechanism control section 255 may be comprised of one control section.

Further, as the support mechanism 500 employed in the sixth embodiment, for example, any of the support mechanisms 500 according to the first to third embodiments described above may be employed.

While, in the sixth embodiment, the setup method of the projection display apparatus 100 is specified in accordance with specific information acquired from the input interface 251 or receiving section 252, a means for specifying the setup method of the projection display apparatus 100 is not limitative thereto. For example, with a sensor such as an acceleration sensor being incorporated in the projection display apparatus 100, the setup method of the projection display apparatus 100 may be specified according to a detection result of the sensor.

(Function(s) and Advantageous Effect(s))

In the sixth embodiment, the image control section 253 controls the orientation of the image displayed on the projection plane 210, in accordance with the setup method of the projection display apparatus 100 (i.e., the state of the reflection optical element 330). Therefore, even in a case where floor-placed setup and ceiling-suspended setup are switched from each other, an appropriate image can be displayed on the projection plane 210.

In the sixth embodiment, the open/close mechanism control section 255 controls the open/close mechanism 600 in accordance with the setup method of the projection display apparatus 100 (i.e., the state of the reflection optical element 330). That is, the open/dose mechanism control section 255 controls the open/close mechanism 600 so as to close an opening, which is not employed in projection of image light, by means of a capping member. In this manner, the entry of foreign matter such as dust or grime into equipment through the opening can be automatically restrained.

### Seventh Embodiment

### Configuration of Projection Display Apparatus

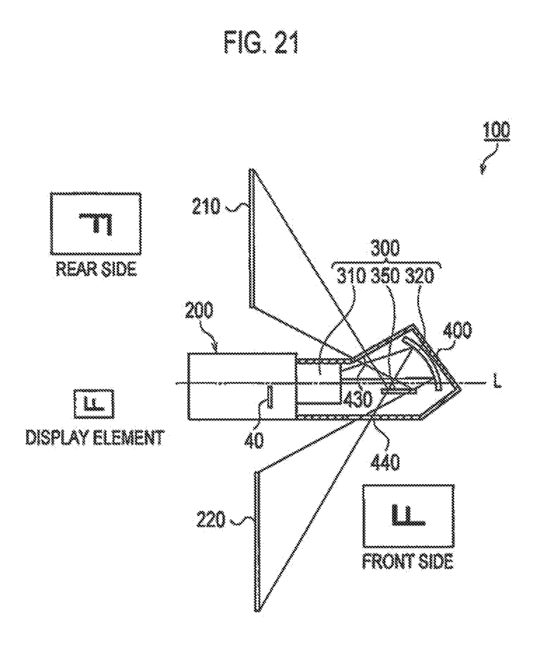

Hereinafter a configuration of a projection display apparatus according to a seventh embodiment will be described with reference to the drawings. FIG. 21 is a view showing a configuration of a projection display apparatus 100 according to the seventh embodiment.

As shown in FIG. 21, the projection display apparatus 100 has an image light generating unit 200, a projection optical unit 300, and a protection cover 400.

The image light generating unit 200 generates image light. Specifically, the image light generating unit 200 has at least a display element 40 for emitting image light. The display element 40 is provided at a position which is shifted relative to an optical axis L of the projection optical unit 300. The display element 40 is a reflective liquid crystal panel, a transmissive liquid crystal panel, a DMD (Digital Micromirror Device) or the like, for example. The image light generating unit 200 has a configuration which is similar to that of FIG. 5.

The projection optical unit 300 projects the image light emitted from the image light generating unit 200. Here, the projection optical unit 300 projects the image light on a plurality of projection planes (projection plane 210 and projection plane 220). Specifically, the projection optical unit 300 has a projection lens 310, a reflection mirror 320, and a half mirror 350.

The projection lens 310 emits the image light emitted from the image light generating unit 200 to the side of the reflection mirror 320.

The reflection mirror 320 reflects the image light emitted from the projection lens 310. The reflection mirror 320 widely angles the image light after focusing the image light. For example, the reflection mirror 320 is a non-spherical mirror having a concave face on the side of the image light generating unit 200.

The half mirror 350 is provided on the optical path of the image light reflected by the reflection mirror 320. The half mirror 350 reflects one portion of the image light reflected by the reflection mirror 320 to the side of the projection plane 210. On the other hand, the half mirror 350 transmits another portion of the image light reflected by the reflection mirror 320 to the side of the projection plane 220.

The protection cover 400 is a cover for protecting the reflection mirror 320. The protection cover 400 is provided at least on the optical path of the image light reflected by the reflection mirror 320. The protection cover 400 has a transmissive region for transmitting image light. Specifically, the protection cover 400 has a transmissive region 430 for transmitting one portion of the image light reflected by the reflection mirror 320; and a transmissive region 440 for transmitting another portion of the image light reflected by the reflection mirror 320. In the seventh embodiment, the transmissive region 430 is provided on a side face of the protection cover 400 opposite to the transmissive region 440.

That is, the transmissive region 430 transmits one portion of the image light reflected by the half mirror 350 to the side of the projection plane 210. The transmissive region 440 transmits another portion of the image light transmitted the half mirror 350 to the side of the projection plane 220.

In this manner, the projection optical unit 300 projects one portion of the image light transmitting the transmissive region 430, on the projection plane 210. The projection optical unit 300 projects another portion of the image light transmitting the transmissive region 440, on the projection plane 220.

Here, the projection plane 210 functions as a transmissive screen for displaying an image through transmission of image light, for example. The projection plane 220 functions as a reflective screen for displaying an image by reflection of image light, for example.

Here, it is merely described that in a case where screens is of same type (transmissive or reflective screens) the orientation of the image displayed on the projection plane 210 is laterally inverted relative to that of the image displayed on the projection plane 220. Therefore, the projection plane 210 may be a reflective screen, whereas the projection plane 220 may be a transmissive screen.

(Image Display Example(s))

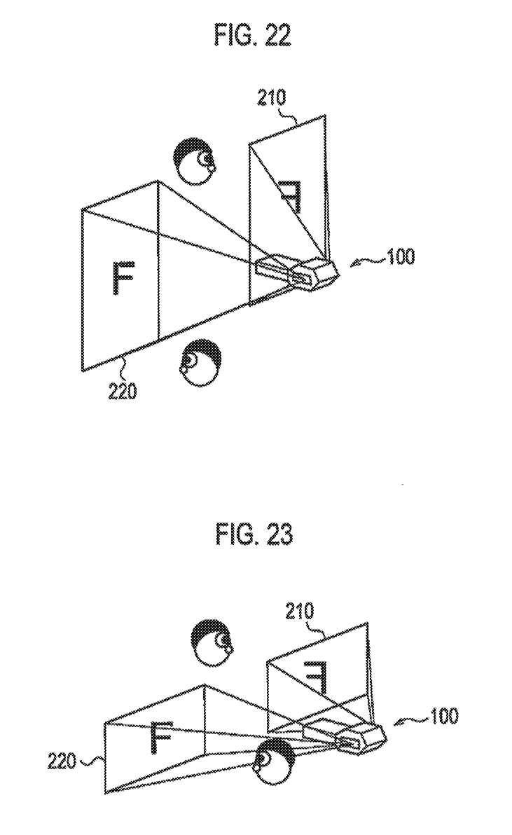

Hereinafter, image display examples according to the seventh embodiment will be described with reference to the drawings. FIG. 22 and FIG. 23 are views showing the image display examples according to the seventh embodiment.

Here, the orientations of images displayed on the projection plane 210 and the projection plane 220 are changed according to the dispositions of the projection display apparatus 100 and the display element 40. Here is illustrated a case in which the projection display apparatus 100 is disposed so that the transmissive region 430 and the transmissive region 440 are provided at the left and right sides of the projection display apparatus 100.

As shown in FIG. 22, in a case in which the display element 40 is provided so as to be longer in a vertical direction than in a horizontal direction, longer images in a vertical direction than in a horizontal direction are displayed on the projection plane 210 and the projection plane 220.

On the other hand, as shown in FIG. 23, in a case in which the display element 40 is provided so as to be longer in a horizontal direction than in a vertical direction, longer images in a horizontal direction than in a vertical direction are displayed on the projection plane 210 and the projection plane 220.

(Function(s) and Advantageous Effect(s))

In the seventh embodiment, the half mirror 350 reflects one portion of the image light reflected by the reflection mirror 320 to the side of the projection plane 210 and transmits another portion of the image light reflected by the reflection mirror 320 to the side of the projection plane 220. Therefore, images can be displayed on two sites by means of one projection display apparatus 100.

Further, the reflection mirror 320 focuses the image light emitted from the image light generating unit 200, and the half mirror is provided on the optical path of the image light reflected by the reflection mirror 320. Therefore, upsizing of the projection display apparatus 100 can be restrained.

In this manner, in a case in which images are displayed on a plurality of projection plane (projection plane 210 and projection plane 220), even where an attempt is made to reduce a distance between the projection display apparatus 100 and each of the projection planes, upsizing of the projection display apparatus 100 can be restrained.

In the seventh embodiment, the protection cover 400 is provided on the optical path of the image light reflected by the reflection mirror 320. Therefore, an angle or the like of the reflection mirror 320 can be restrained from being varied by a user touching the reflection mirror 320. Further, the protection cover 400 has transmissive regions (transmissive region 430 and transmissive region 440) for transmitting the image light reflected by the reflection mirror 320. Accordingly, the image light with which the projection planes (projection plane 210 and projection plane 220) are irradiated is never interrupted by the protection cover 400. In this manner, the disposition precision of the reflection mirror 320 provided to reduce a distance between the projection display apparatus 100 and each of the projection planes can be appropriately maintained.

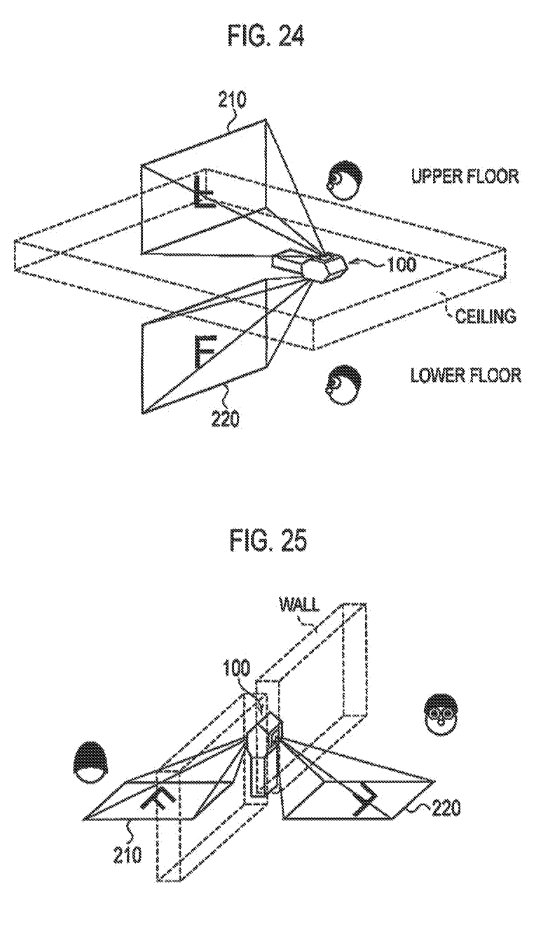

As a setup site of the projection display apparatus 100, as shown in FIG. 24, there is considered a ceiling (floor) which is provided between an upper floor and a lower floor. In this manner, images can be displayed on the wall surfaces of the upper floor and the lower floor, respectively.

As a setup site of the projection display apparatus 100, as shown in FIG. 25, there is considered a wall which is provided between a plurality of passageways. In this manner, images can be displayed on the floor surfaces of these passageways, respectively.

As a setup site of the projection display apparatus 100, there is considered the inside of a display window which is provided at a shop. In this manner, an image can be shown to customers in the shop or pedestrians outside the shop.

### Exemplary Modification of the Seventh Embodiment

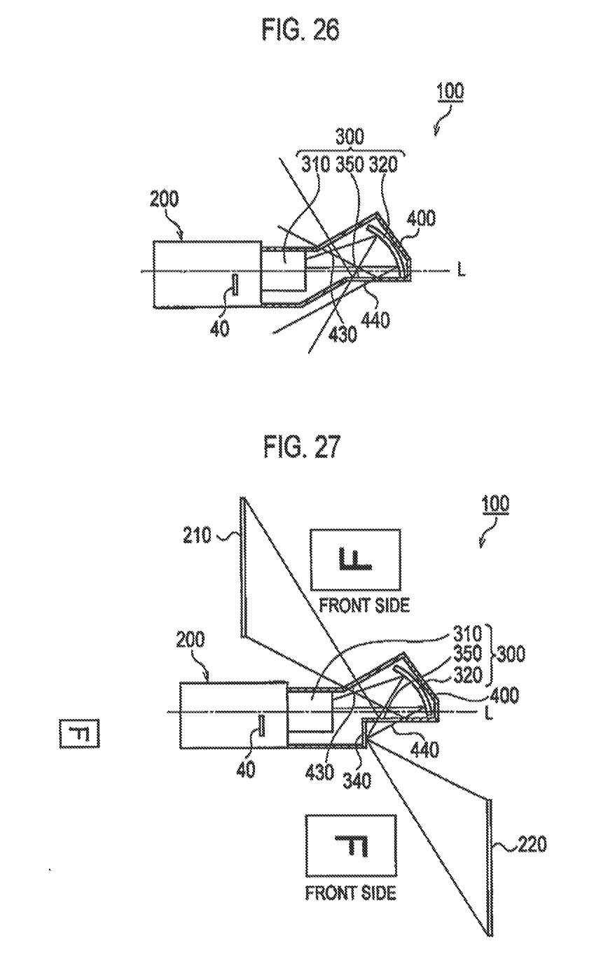

Hereinafter, an exemplary modification of the seventh embodiment will be described with reference to the drawings. Hereinafter, differences from the seventh embodiment will be mainly described. Specifically, in the exemplary modification of the seventh embodiment, as shown in FIG. 26, a half mirror 350 is a transmissive region 440. That is, the half mirror 350 is employed as the transmissive region 440.

(Function(s) and Advantageous Effect(s))

In the exemplary modification of the seventh embodiment, the half mirror 350 is employed as the transmissive region 440. Therefore, the number of parts in the projection display apparatus 100 can be reduced and the projection display apparatus 100 can be downsized.

### Eighth Embodiment

Hereinafter, an eighth embodiment will be described with reference to the drawings. Hereinafter, differences between the seventh embodiment and the eighth embodiment will be mainly described.

Specifically, in the eighth embodiment, as shown in FIG. 27, a half mirror 350 is employed as a transmissive region 440, like the exemplary modification of the seventh embodiment.

A projection optical unit 300 has a reflection mirror 340 provided on an optical path of the image light transmitting the half mirror 350 (transmissive region 440). The reflection mirror 340 is provided on the optical path of the image light transmitting the half mirror 350 (transmissive region 440). The reflection mirror 340 reflects the image light transmitting the half mirror 350 (transmissive region 440) to the side of a projection plane 220. It is preferable that the reflection mirror 340 is provided as part of the protection cover 400.

Here, even in a case where screens are of same type (transmissive or reflective screens), the orientation of the image displayed on the projection plane 210 is not laterally inverted relative to that of the image displayed on the projection plane 220. Therefore, screens of same type (transmissive or reflective screens) can be employed as the projection plane 210 and the projection plane 220.

(Image Display Example(s))

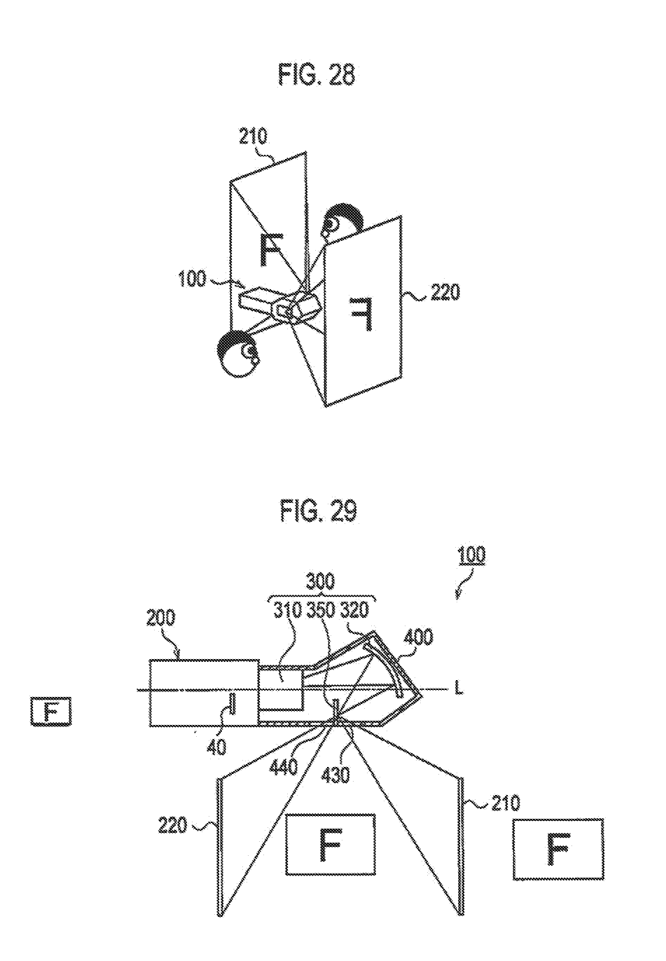

Hereinafter, an image display example according to the eighth embodiment will be described with reference to the drawings. FIG. 28 is a view showing the image display example according to the eighth embodiment.

Here is illustrated a case in which the projection display apparatus 100 is disposed so that the transmissive region 430 and the transmissive region 440 are provided at the left and right sides of the projection display apparatus 100. Here is also illustrated a case in which the display element 40 is disposed so as to be longer in a vertical direction than in a horizontal direction.

As shown in FIG. 28, screens of same type (reflective screens) can be employed as the projection plane 210 and the projection plane 220. Further, longer images in a vertical direction than in a horizontal direction are displayed on the projection plane 210 and the projection plane 220.

(Function(s) and Advantageous Effect(s))

In the eighth embodiment, the reflection mirror 340 reflects the image light transmitting the half mirror 350 (transmissive region 440) to the side of the projection plane 220. Therefore, screens of same type (transmissive or reflective screens) can be employed as the projection plane 210 and the projection plane 220.

In a case where the projection plane 210 and the projection plane 220 function as reflective screens, the center of a passageway is considered as a setup site of the projection display apparatus 100. In this manner, images can be displayed on both wall surfaces of the passageway.

In a case where the projection plane 210 and the projection plane 220 function as reflective screens, a revolving shaft of a revolving door is considered as a setup site of the projection display apparatus 100. In this manner, images can be shown to a plurality of pedestrians passing through the revolving door.

In a case where the projection plane 210 and the projection plane 220 function as transmissive screens, a wall interior having its thickness which is capable of housing the projection display apparatus 100 is considered as a setup site of the projection display apparatus 100. In this manner, images can be displayed at the front and back faces of wall.

### Ninth Embodiment

Hereinafter, a ninth embodiment will be described with reference to the drawings. Hereinafter, differences between the seventh embodiment and the ninth embodiment will be mainly described.

Specifically, in the ninth embodiment, as shown in FIG. 29, a transmissive region 430 is provided on a side face of a protection cover 400 in the same manner as that in a transmissive region 440.

The half mirror 350 has an inclination which is substantially vertical relative to a side face of the protection cover 400 on which the transmissive region 430 and the transmissive region 440 are provided. The inclination of the half mirror 350 is not limitative to being substantially vertical relative to the side face of the protection cover 400 on which the transmissive region 430 and the transmissive region 440 are provided. The inclination of the half mirror 350 may be a given inclination.

Like the seventh embodiment, the transmissive region 430 transmits one portion of the image light reflected by the half mirror 350 to the side of the projection plane 210. The transmissive region 440 transmits another portion of the image light transmitting the half mirror 350 to the side of the projection plane 220

Here, the projection plane 210 functions as a transmissive screen for displaying an image by way of transmission of image light, for example. The projection plane 220 functions as a reflective screen for displaying an image by way of reflection of image light, for example.

Here, it is merely described here that in a case where screens are of same type (transmissive or reflective screens), the orientation of the image displayed on the projection plane 210 is laterally inverted relative to that of the image displayed on the projection plane 220. Therefore, the projection plane 210 may be a reflective screen, whereas the projection plane 220 may be a transmissive screen.

(Image Display Example(s))

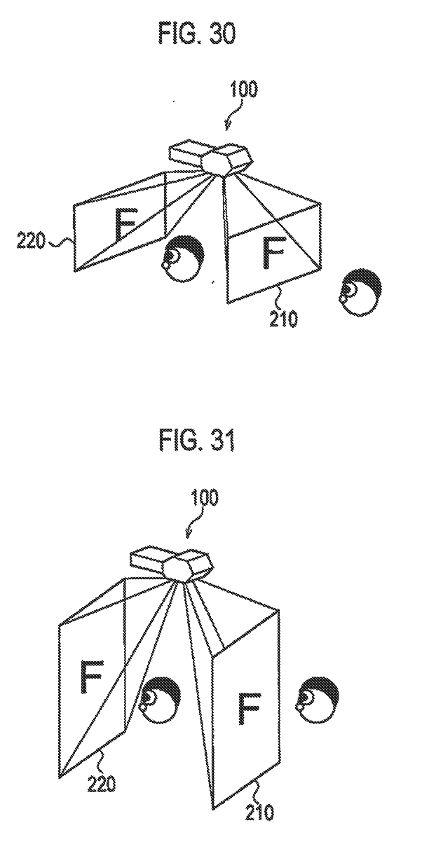

Hereinafter, image display examples according to the ninth embodiment will be described with reference to the drawings. FIG. 30 and FIG. 31 are views showing the image display example(s) according to the ninth embodiment. Here is illustrated a case in which the projection display apparatus 100 is disposed so that the transmissive region 430 and the transmissive region 440 are provided at the lower side of the projection display apparatus 100.

As shown in FIG. 30, in a case in which the display element 40 is provided so as to be longer in a horizontal direction than in a vertical direction, longer images in a horizontal direction than in a vertical direction are displayed on the projection plane 210 and the projection plane 220.

On the other hand, as shown in FIG. 31, in a case in which the display element 40 is provided so as to be longer in a vertical direction than in a horizontal direction, longer images in a vertical direction than in a horizontal direction are displayed on the projection plane 210 and the projection plane 220.

The ninth embodiment illustrated a case in which the projection display apparatus 100 is disposed so that the transmissive region 430 and the transmissive region 440 are provided at a lower side of the projection display apparatus 100. However, the disposition of the projection display apparatus 100 is not limitative thereto. For example, the projection display apparatus 100 may be disposed so that the transmissive region 430 and the transmissive region 440 are provided at an upper side of the projection display apparatus 100. The projection display apparatus 100 may also be disposed so that the transmissive region 430 and the transmissive region 440 are provided at a lateral side of the projection display apparatus 100.

(Function(s) and Advantageous Effect(s))

In the ninth embodiment, the transmissive region 430 is provided on a side face of the protection cover 400 in the same manner as that in the transmissive region 440. In this manner, images can be displayed in two sites at the lower, upper, or lateral side of the projection display apparatus 100.

In a case where the transmissive region 430 and the transmissive region 440 are provided at the lower side of the projection display apparatus 100, a building's ceiling is considered as a setup site of the projection display apparatus 100. In this manner, images can be displayed on a plurality of walls provided in building.

In a case where the transmissive region 430 and the transmissive region 440 are provided at the upper side of the projection display apparatus 100, a building's floor is considered as a setup site of the projection display apparatus 100. In this manner, images can be displayed on a plurality of walls provided in building.

### Tenth Embodiment

### Configuration of Projection Display Apparatus

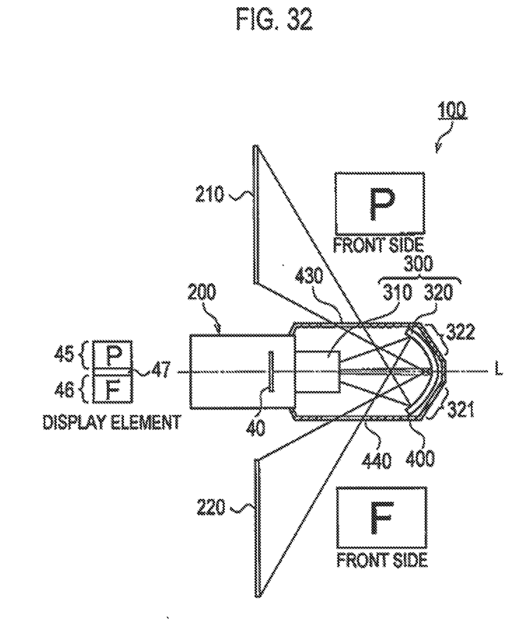

Hereinafter, a configuration of a projection display apparatus according to a tenth embodiment will be described with reference to the drawings. FIG. 32 is a view showing a configuration of a projection display apparatus 100 according to the tenth embodiment.

As shown in FIG. 32, the projection display apparatus 100 has an image light generating unit 200, a projection optical unit 300, and a protection cover 400.

The image light generating unit 200 generates image light. Specifically, the image light generating unit 200 has at least a display element 40 for emitting image light. The display element 40 is a reflective liquid crystal panel, a transmissive liquid crystal panel, a DMD (Digital Micromirror Device) or the like, for example. The image light generating unit 200 has a configuration which is similar to that of FIG. 5.

Here, the display element 40 has: a first display region 45 for emitting first image light corresponding to a first image; and a second display region 46 for emitting second image light corresponding to a second image. The first image and the second image may be identical to each other or may be different therefrom. Further, in order to separate the first image light and the second image light from each other, a separation region 47 is provided between the first display region 45 and the second display region 46. It is preferable that the separation region 47 is configured so as not to emit light. That is, it is preferable that a black image is displayed on the separation region 47.

Here, the first display region 45 and the second display region 46 are provided at positions which are shifted relative to an optical axis L of the projection optical unit 300. Here, the first display region 45 is provided at a position which is shifted upside relative to the optical axis L of the projection optical unit 300. The second display region 46 is provided at a position which is shifted downside relative to the optical axis L of the projection optical unit 300.

The projection optical unit 300 projects the image light emitted from the image light generating unit 200 (first image light and second image light), on a plurality of projection planes. Here, the projection optical unit 300 projects the first image light on a projection plane 210 and projects the second image light on a projection plane 220. Specifically, the projection optical unit 300 has a projection lens 310 and a reflection mirror 320.

The projection lens 310 emits the image light (first image light and second image light) emitted from the image light generating unit 200 to the side of the reflection mirror 320.

The reflection mirror 320 reflects the image light (first image light and second image light) emitted from the projection lens 310. The reflection mirror 320 widely angles the first image light and the second image light, respectively, after focusing the first image light and the second image light, respectively. For example, the reflection mirror 320 is a non-spherical mirror having a concave face on the side of the image light generating unit 200.

Here, the reflection mirror 320 has: a first reflective region 321 for reflecting the first image light emitted from the first display region 45 and focusing the first image light; and a second reflective region 322 for reflecting the second image light emitted from the second display region 46 and focusing the first image light.

Here, the first reflective region 321 and the second reflective region 322 are provided at positions which are shifted relative to the optical axis L of the projection optical unit 300. Specifically, since the first display region 45 is provided at a position which is shifted upside relative to the optical axis L, the first image light is emitted in an obliquely downward direction. Therefore, the first reflective region 321 is provided at a position which is shifted downside relative to the optical cods L of the projection optical unit 300. On the other hand, since the second display region 46 is provided at a position which is shifted downside relative to the optical axis L, the second image light is emitted in an obliquely upward direction. Accordingly, the second reflective region 322 is provided at a position which is shifted upside relative to the optical axis L of the projection optical unit 300.

The protection cover 400 is a cover for protecting the reflection mirror 320. The protection cover 400 is provided at least on the optical path of the image light reflected by the reflection mirror 320. The protection cover 400 has a transmissive region for transmitting image light. Specifically, the protection cover 400 has: a transmissive region 430 for transmitting the first image light reflected by a first reflective region 321; and a transmissive region 440 for transmitting the second image light reflected by a second reflective region 322. In the tenth embodiment, the transmissive region 430 is provided on a side face of the protection cover 400 opposite to the transmissive region 440.

In this manner, the projection optical unit 300 projects the first image light transmitting the transmissive region 430, on the projection plane 210. The projection optical unit 300 projects the second image light transmitting the transmissive region 440, on the projection plane 220.

Here, the projection plane 210 is a reflective screen for displaying an image by way of reflection of image light, for example. The projection plane 220 is a reflective screen for displaying an image by way of reflection of image light, for example.

However, a first image displayed in the first display region 45 or a second image displayed in the second display region 46 is laterally inverted, whereby the orientation of the images displayed on the projection plane 210 and the projection plane 220 can be coordinated. Therefore, screens of given type (reflective or transmissive screens) can be employed as the projection plane 210 and the projection plane 220.

(Image Display Example(s))

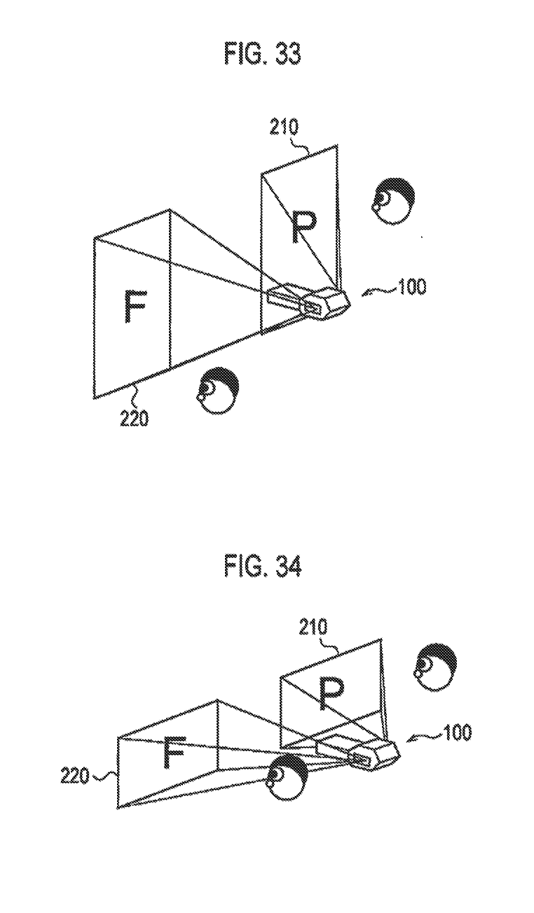

Hereinafter, image display examples according to the tenth embodiment will be described with reference to the drawings. FIG. 33 and FIG. 34 are views showing the image display examples according to the tenth embodiment.

Here, the images displayed on the projection plane 210 and the projection plane 220 are changed depending upon dispositions of the projection display apparatus 100 and the display element 40. Here is illustrated a case in which the projection display apparatus 100 is disposed so that the transmissive region 430 and the transmissive region 440 are provided at the left and right sides of the projection display apparatus 100.

As shown in FIG. 33, in a case in which the display element 40 is provided so that the first display region 45 and the second display region 46 are longer in a vertical direction than in a horizontal direction, longer images in a vertical direction than in a horizontal direction are displayed on the projection plane 210 and the projection plane 220.

On the other hand, as shown in FIG. 34, in a case in which the display element 40 is provided so that the first display region 45 and the second display region 46 are longer in a horizontal direction than in a vertical direction, longer images in a horizontal direction than in a vertical direction are displayed on the projection plane 210 and the projection plane 220.

(Function(s) and Advantageous Effect(s))

In the tenth embodiment, the display element 40 has the first display region 45 and the second display region 46, and the reflection mirror 320 has the first reflective region 321 and the second reflective region 322. Therefore, images can be displayed at two sites by means of one projection display apparatus 100.

Further, the first reflective region 321 focuses the first image light emitted from the first display region 45. The second reflective region 322 focuses the second image light emitted from the second display region 46. Therefore, upsizing of the projection display apparatus 100 can be restrained.

In this manner, in a case in which images are displayed on a plurality of projection planes (projection plane 210 and projection plane 220), even where an attempt is made to reduce a distance between the projection display apparatus 100 and each of the projection planes, upsizing of the projection display apparatus 100 can be restrained.

Further, the display element 40 has the first display region 45 for emitting the first image light and the second display region 46 for emitting the second image light. Therefore, different images can be displayed on the projection plane 210 and the projection plane 220.

In the tenth embodiment, the protection cover 400 is provided on the optical path of the image light reflected by the reflection mirror 320. Therefore, an angle or the like of the reflection mirror 320 can be restrained from being varied by a user touching the reflection mirror 320. In addition, the protection cover 400 has transmissive regions (transmissive region 430 and transmissive region 440) for transmitting the image light reflected by the reflection mirror 320. Accordingly, the image light with which the projection planes (projection plane 210 and projection plane 220) are irradiated is never interrupted by the protection cover 400. In this manner, disposition precision of the reflection mirror 320 provided to reduce a distance between the projection display apparatus 100 and each of the projection planes can be appropriately maintained.

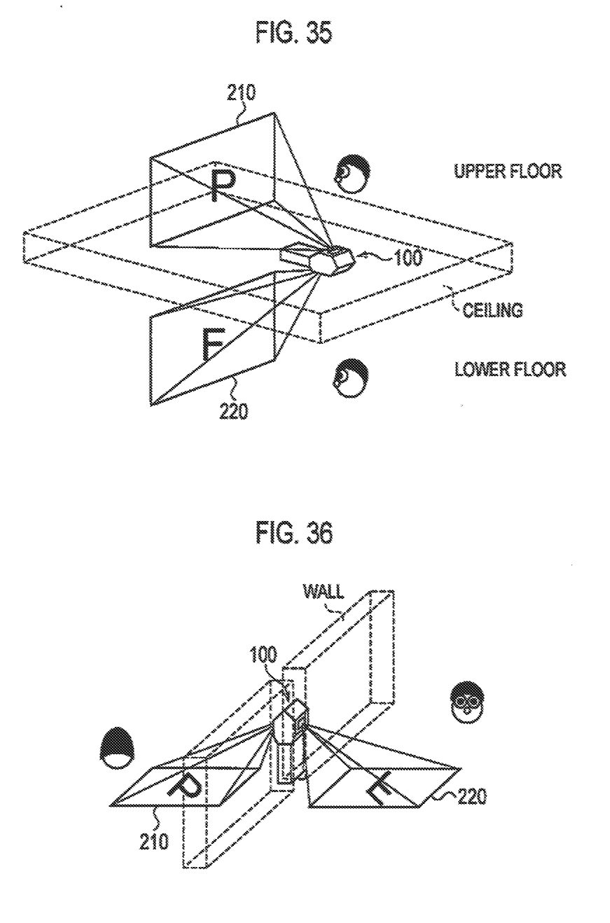

As a setup site of the projection display apparatus 100, there is considered a ceiling (floor) which is provided between an upper floor and a lower floor, as shown in FIG. 35. In this manner, images can be displayed on wall surfaces of the upper floor and the lower floor respectively.

As a setup site of the projection display apparatus 100, there is considered a wall which is provided between a plurality of passageways, as shown in FIG. 36. In this manner, images can be displayed on the floor surfaces of the passageways, respectively. It should be noted that the top and bottom of the second image displayed in the second display region 46 are inverted relative to the first image displayed in the first display region 45.

The inside of a display window which is provided at a shop is considered as a setup site of the projection display apparatus 100. In this manner, an image can be shown to customers in the shop or pedestrians outside the shop.

### Exemplary Modification of the Tenth Embodiment

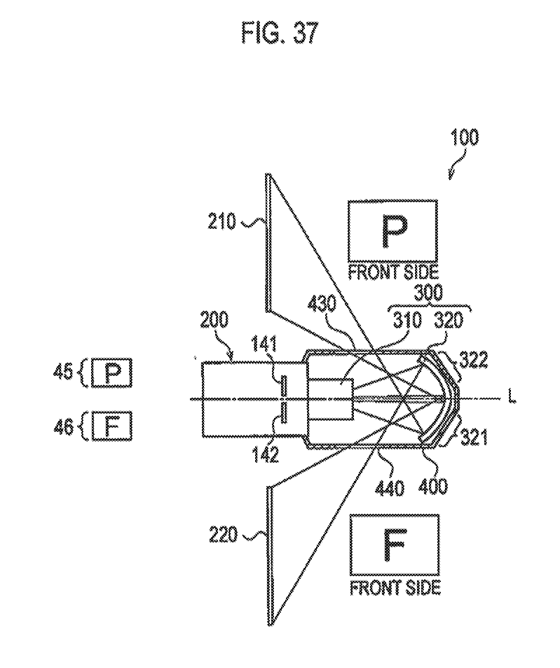

Hereinafter, an exemplary modification of the tenth embodiment will be described with reference to the drawings. Hereinafter, differences from the tenth embodiment will be mainly described. Specifically, in the exemplary modification of the tenth embodiment, as shown in FIG. 37, display elements 40 include a first display element 141 having a first display region 45 and a second display element 142 having a second display region 46.

(Function(s) and Advantageous Effect(s))

In the exemplary modification of the tenth embodiment, the first display region 45 and the second display region 46 are provided in separate display elements 40 (the first display element 141 and the second display element 142). Therefore, there is no need to, provide the abovementioned separation region 47 at the display element 40. In addition, images of different resolutions or images of different sizes can be displayed on the projection plane 210 and the projection plane 220.

### Eleventh Embodiment

Hereinafter, an eleventh embodiment will be described with reference to the drawings. Hereinafter, differences between the tenth embodiment and the eleventh embodiment will be mainly described.

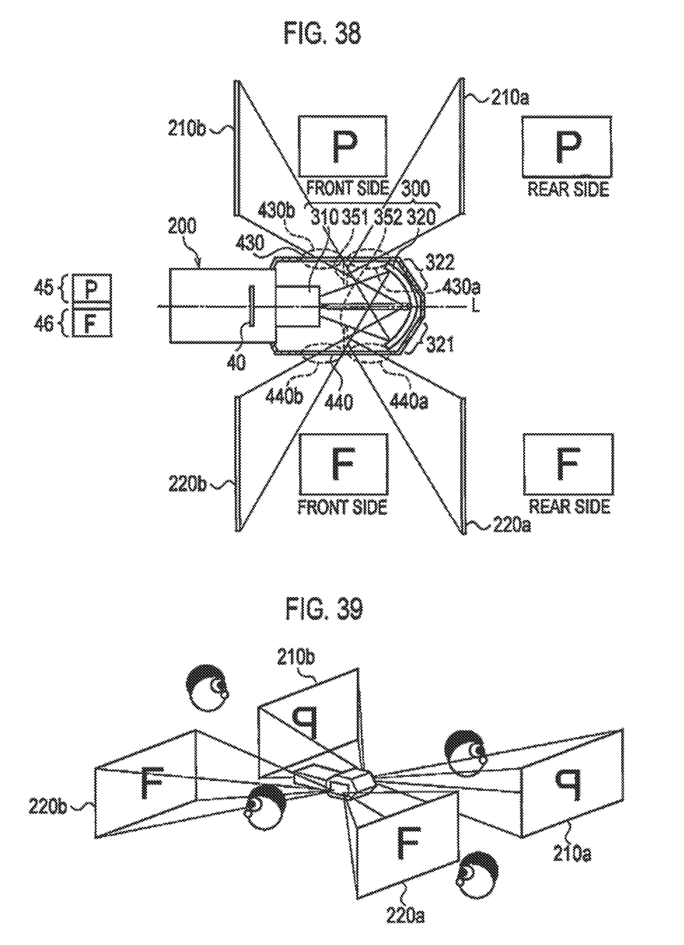

Specifically, in the eleventh embodiment, as shown in FIG. 38, a projection optical unit 300 has a first half mirror 351 and a second half mirror 352. A transmissive region 430 has a transmissive region 430a and a transmissive region 430b. A transmissive region 440 has a transmissive region 440a and a transmissive region 440b.

The first half mirror 351 is provided on an optical path of the first image light reflected by a first reflective region 321. The first half mirror 351 reflects one portion of the first image light to the side of the transmissive region 430a and transmits one portion of the first image light to the side of the transmissive region 430b. Here, the first half mirror 351 has a substantially vertical inclination relative to the transmissive region 430. This half mirror is also provided at a boundary between the transmissive region 430a and the transmissive region 430b.

The second half mirror 352 is provided on an optical path of the second image light reflected by a second reflective region 322. The second half mirror 352 reflects one portion of the second image light to the side of the transmissive region 440a and transmits one portion of the second image light to the side of the transmissive region 440b. Here, the second half mirror 352 has an inclination which is substantially vertical relative to the transmissive region 440. This half mirror is also provided at a boundary between the transmissive region 440a and the transmissive region 440b.

The projection optical unit 300 projects one portion of the first image light reflected by the first half mirror 351, on a projection plane 210a via the transmissive region 430a, and projects another portion of the first image light transmitting the first half mirror 351, on a projection plane 210b via the transmissive region 430b.

The projection optical unit 300 projects one portion of the second image light reflected by the second half mirror 352, on the projection plane 220a via the transmissive region 440a, and projects another portion of the second image light transmitting the second half mirror 352, on the projection plane 220b via the transmissive region 440b.

(Image Display Example(s))

Hereinafter, an image display example according to the eleventh embodiment will be described with reference to the drawings. FIG. 39 is a view showing the image display example according to the eleventh embodiment.

Here, the orientations of the images that are displayed on the projection plane 210a and the projection plane 210b are changed according to the dispositions of the projection display apparatus 100 and the display element 40. Similarly, the orientations of the images that are displayed on the projection plane 220a and the projection plane 220b are changed according to the dispositions of the projection display apparatus 100 and the display element 40.

Here is illustrated a case in which the projection display apparatus 100 is disposed so that the transmissive region 430 and the transmissive region 440 are provided at the left and right sides of the projection display apparatus 100.

It should be noted that the orientation of a first image which is displayed in a first display region 45 is laterally inverted relative to that of a second image which is displayed in a second display region 46 in FIG. 39. As shown in FIG. 39, the projection plane 210a and the projection plane 220b function as screens of same type (reflective screens). On the other hand, the projection plane 210b and the projection plane 220a function as screens of same type (transmissive screens).

Here, let us consider that the orientation of the first image that is displayed in the first display region 45 is identical to that of the second image that is displayed in the second display region 46. In such a case, the projection plane 210a and the projection plane 220a function as screens of same type (reflective or transmissive screens). On the other hand, the projection plane 210a and the projection plane 220b function as screens of same type (reflective or transmissive screens).

(Function(s) and Advantageous Effect(s))

In the eleventh embodiment, the projection optical unit 300 has the first half mirror 351 and the second half mirror 352. Therefore, more images can be displayed by one projection display apparatus 100.

### Twelfth Embodiment

### Configuration of Projection Display Apparatus

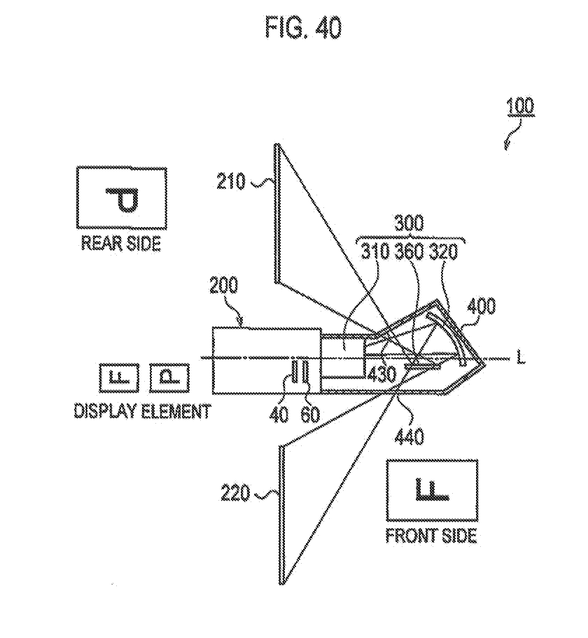

Hereinafter, a configuration of a projection display apparatus according to a twelfth embodiment will be described with reference to the drawings. FIG. 40 is a view showing a configuration of a projection display apparatus 100 according to the twelfth embodiment.

As shown in FIG. 40, the projection display apparatus 100 has an image light generating unit 200, a projection optical unit 300, and a protection cover 400.

The image light generating unit 200 generates image light. Specifically, the image light generating unit 200 has at least a display element 40 emitting image light. The display element 40 is provided at a position which is shifted relative to an optical axis L of the projection optical unit 300. The display element 40 is a reflective liquid crystal panel, a transmissive liquid crystal panel, a DMD (Digital Micromirror Device) or the like, for example.

Here, the display element 40 displays a first image and a second image alternately in time division. The first image and the second image may be identical to each other or may be different therefrom. As described later, the first image light corresponding to the first image is adjusted into the first polarization (for example, P-polarization or S-polarization) by means of a polarization adjusting element 60. On the other hand, the second image light corresponding to the second image is adjusted into the second polarization (for example, S-polarization or P-polarization) by means of a polarization adjusting element 60. A detailed description of the image light generating unit 200 will be given (see FIG. 41).

The projection optical unit 300 projects the image light emitted from the image light generating unit 200, on a plurality of projection planes. Here, the projection optical unit 300 projects the first image light on the projection plane 210 and projects the second image light on the projection plane 220. Specifically, the projection optical unit 300 has a projection lens 310, a reflection mirror 320, and a reflective polarization plate 360.

The projection lens 310 emits the image light (first image light and second image light) emitted from the image light generating unit 200 to the side of the reflection mirror 320.

The reflection mirror 320 reflects the image light (first image light and second image light) emitted from the projection lens 310. The reflection mirror 320 widely angles the first image light and the second image light, respectively, after focusing the first image light and the second image light, respectively. For example, the reflection mirror 320 is a non-spherical mirror having a concave face on the side of the image light generating unit 200.

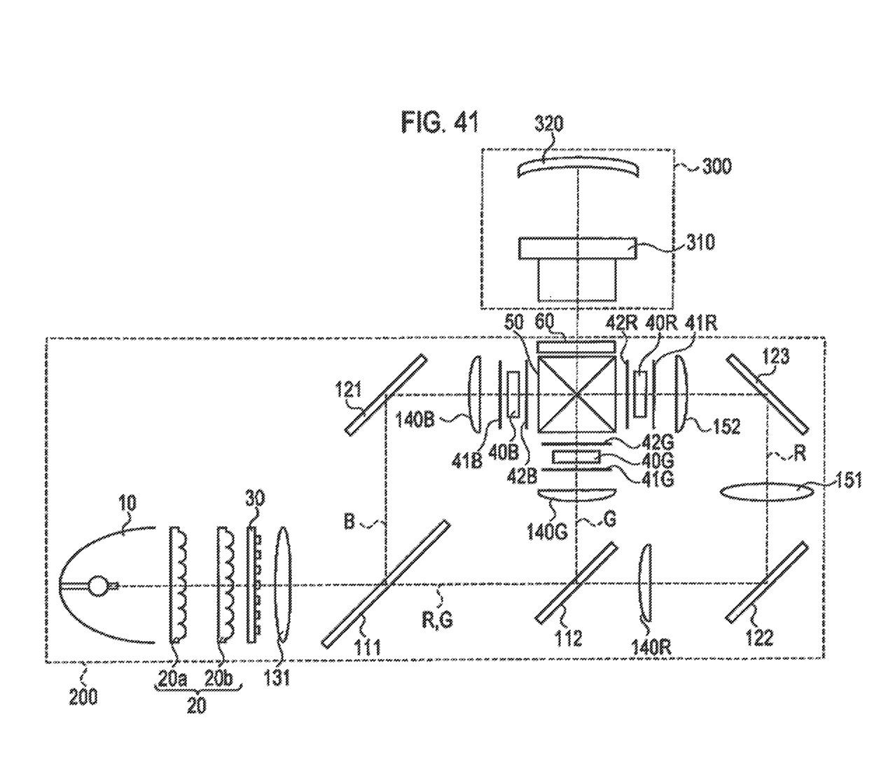

The reflective polarization plate 360 is provided on the optical path of the image light (first image light and second image light) reflected by the reflection mirror 320. The reflective polarization plate 360, as shown in FIG. 42, reflects the first polarization (for example, S-polarization) and transmits the second polarization (for example, P-polarization). Specifically, the reflective polarization plate 360 reflects the first image light adjusted into the first polarization to the side of the projection plane 210 and transmits the second image light adjusted into the second polarization to the aide of the projection plane 220.

The protection cover 400 is a cover for protecting the reflection mirror 320. The projection cover 400 is provided at least on the optical path of the image light reflected by the reflection mirror 320. The protection cover 400 has a transmissive region for transmitting image light. Specifically, the protection cover 400 has: a transmissive region 430 for transmitting the first image light reflected by the reflection mirror 320; and a transmissive region 440 for transmitting the second image light reflected by the reflection mirror 320. In the twelfth embodiment, the transmissive region 430 is provided on a side face of the protection cover 400 opposite to the transmissive region 440.

That is, the transmissive region 430 transmits the first image light reflected by the reflective polarization plate 360 to the side of the projection plane 210. The transmissive region 440 transmits the second image light transmitting the reflective polarization plate 360 to the side of the projection plane 220.

In this manner, the projection optical unit 300 projects the first image light transmitting the transmissive region 430, on the projection plane 210. The projection optical unit 300 projects the second image light transmitting the transmissive region 440, on the projection plane 220.

Here, the projection plane 210 is a transmissive screen for displaying an image by means of transmission of image light, for example. The projection plane 220 is a reflective screen for displaying an image by means of reflection of image light, for example.

By laterally inverting the first image or the second image that a liquid crystal panel 40 displays, the orientations of the images that are displayed on the projection plane 210 and the projection plane 220 can be adjusted into each other. Therefore, screens of given type (reflective or transmissive screens) can be employed as the projection plane 210 and the projection plane 220.

(Configuration of Image Light Generating Unit)

Hereinafter, a configuration of an image light generating unit according to the twelfth embodiment will be described with reference to the drawings. FIG. 41 is a view mainly showing an image light generating unit 200 according to the twelfth embodiment. In FIG. 41, like constituent elements shown in FIG. 5 are designated by like reference numerals. The image light generating unit 200 has a power circuit (not shown) and an image signal processing circuit (not shown) in addition to the constituent elements shown in FIG. 41. Here is illustrated a case in which a display element 40 is a transmissive liquid crystal panel.

The image light generating unit 200 has a polarization adjusting element 60 in addition to the constituent elements shown in FIG. 5.

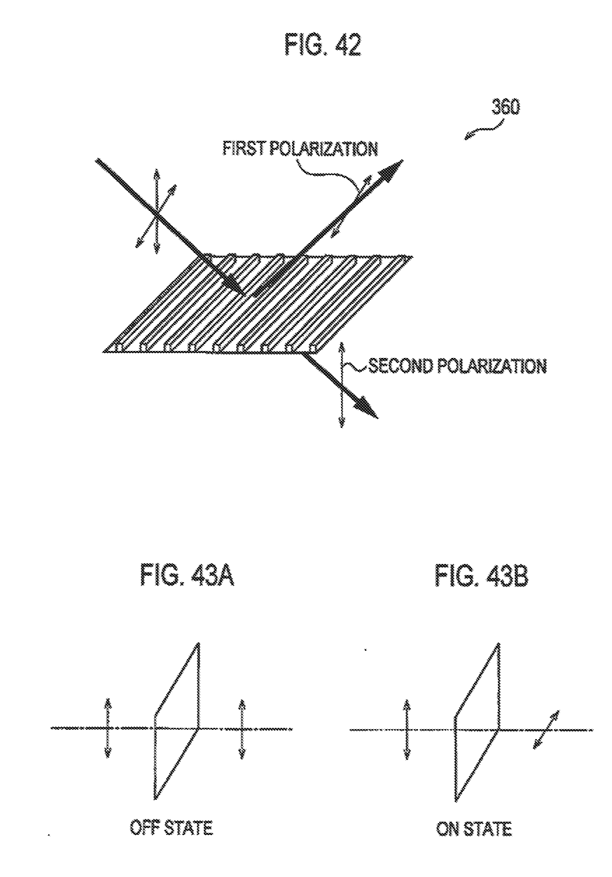

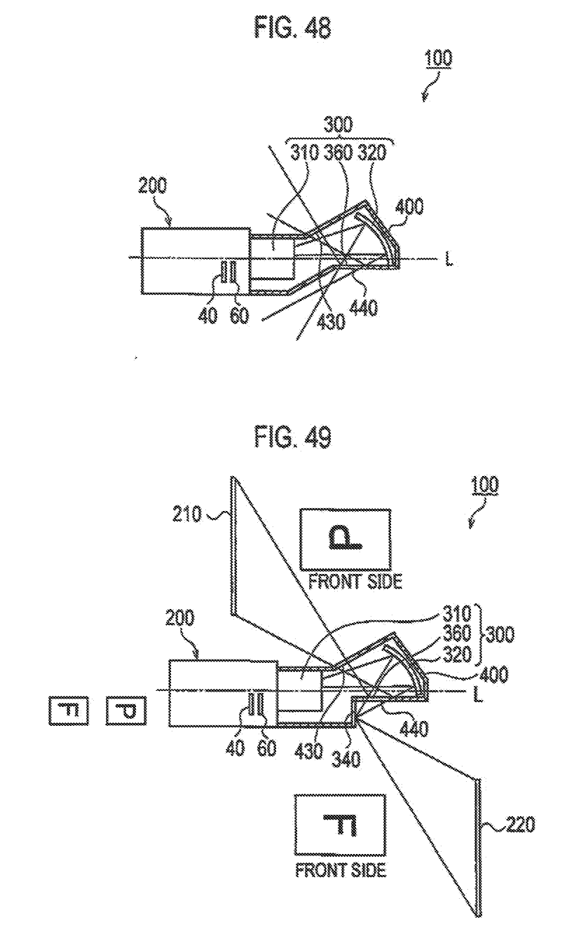

The polarization adjusting element 60 is a liquid crystal modulation element or the like for switching a polarization state of light transmitting its own element at a high speed with a given timing by means of electrical control. For example, as shown in FIG. 48(A), the polarization adjusting element 60 transmits incident light while polarization of the incident light is left as it is, in a state in which no voltage is applied to its own element (OFF state). On the other hand, as shown in FIG. 43(B), the polarization adjusting element 60 transmits incident light while polarization of the incident light is rotated at an angle of substantial 90 degrees, in a state in which a voltage is applied to its own element (ON state).

Specifically, out of the image light emitted from a cross-dichroic prism 50, the polarization adjusting element 60 adjusts the first image light, which corresponds to the first image, into the first polarization and adjusts the second image light, which corresponds to the second image, into the second polarization.

Here, the first image light is reflected by the reflective polarization plate 360, as described above. Therefore, it is preferable that the polarization adjusting element 60 adjusts polarization of the first image light so as to become S-polarization in the reflective polarization plate 360. On the other hand, the second image light transmits the reflective polarization plate 360, as described above. Therefore, it is preferable that the polarization adjusting element 60 adjusts polarization of the second image light so as to become P-polarization in the reflective polarization plate 360.

In a case where the polarization of each color component light emitted from the cross-dichroic prism 50 is incomplete, the polarization adjusting element 60 may be combined with a narrow-band phase difference plate for coordinating only polarization of light having a specific wavelength band. In addition, the polarization adjusting element 60 may be a liquid crystal modulation element for selectively coordinating the wavelength band of each color component light to a given polarization.

While the polarization adjusting element 60 is provided at the light emission side of the cross-dichroic prism 50, disposition of the polarization adjusting element 60 is not limitative thereto. For example, the polarization adjusting element 60 may be provided at the light emission side of each liquid crystal panel 40 independently.

(Image Display Example(s))

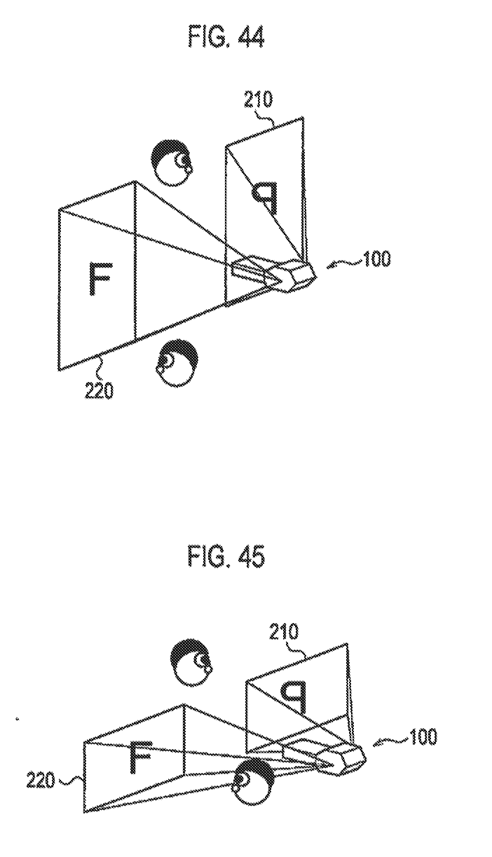

Hereinafter, image display examples according to the twelfth embodiment will be described with reference to the drawings. FIG. 44 and FIG. 45 are views showing the image display examples according to the twelfth embodiment.

Here, the orientations of the images displayed on the projection plane 210 and the projection plane 220 are changed depending upon the dispositions of the projective display apparatus 100 and the display element 40. Here is illustrated a case in which the projection display apparatus 100 is disposed so that the transmissive region 430 and the transmissive region 440 are provided at the left and right sides of the projection display apparatus 100.

As shown in FIG. 44, in a case in which the display element 40 is provided to be longer in a vertical direction than in a horizontal direction, longer images in a vertical direction than in a horizontal direction are displayed on the projection plane 210 and the projection plane 220.

On the other hand, as shown in FIG. 45, in a case in which the display element 40 is provided to be longer in a horizontal direction than in a vertical direction, longer images in a horizontal direction than in a vertical direction are displayed on the projection plane 210 and the projection plane 220.

(Function(s) and Advantageous Effect(s))

In the twelfth embodiment, the polarization adjusting element 60 adjusts the first image light into the first polarization and adjusts the second image light into the second polarization. The reflective polarization plate 360 reflects the first image light adjusted into the first polarization. On the other hand, the reflective polarization plate 360 transmits the second image light adjusted into the second polarization. Therefore, images can be displayed at two sites by means of one projection display apparatus 100.

In addition, the reflection mirror 320 focuses the image light emitted from the image light generating unit 200. Therefore, upsizing of the projection display apparatus 100 can be restrained.

In this manner, in a case in which images are displayed on a plurality of projection planes (projection plane 210 and projection plane 220), even where an attempt is made to reduce a distance between the projection display apparatus 100 and each of the projection planes, upsizing of the projection display apparatus 100 can be restrained.

Further, the display element 40 displays the first image and the second image in time division. Therefore, different images can be displayed on the projection plane 210 and the projection plane 220.

In the twelfth embodiment, the protection cover 400 is provided on the optical path of the image light reflected by the reflection mirror 320. Therefore, an angle or the like of the reflection mirror 320 can be restrained from being varied by a user touching the reflection mirror 320. In addition, the protection cover 400 has transmissive regions (transmissive region 430 and transmissive region 440) for transmitting the image light reflected by the reflection mirror 320. Therefore, the image light with which the projection planes (projection plane 210 and projection plane 220) are irradiated is never interrupted by the protection cover 400. In this manner, disposition precision of the reflection mirror 320 provided to reduce a distance between the projection display apparatus 100 and each of the projection planes can be appropriately maintained.

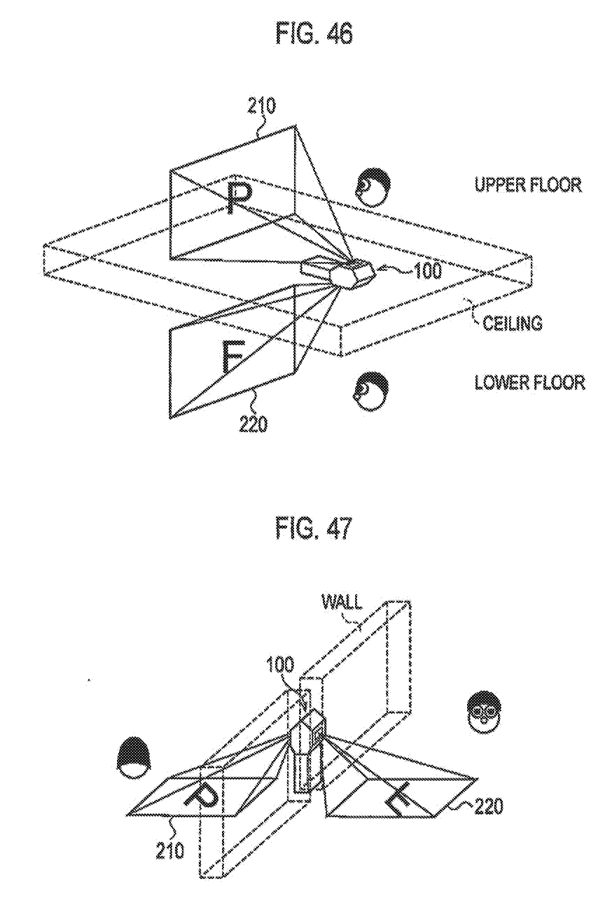

As a setup site of the projection display apparatus 100, there is considered a ceiling (floor) which is provided between an upper floor and a lower floor, as shown in FIG. 46. In this manner, images can be displayed on the wall surfaces of the upper floor and the lower floor respectively.

As a setup site of the projection display apparatus 100, there is considered a wall which is provided between a plurality of passageways, as shown in FIG. 47. In this manner, images can be displayed on the floor surfaces of the passageways, respectively.

As a setup site of the projection display apparatus 100, there is considered the inside of a display window which is provided at a shop. In this manner, an image can be shown to customers in the shop or pedestrians outside the shop.

### Exemplary Modification of Twelfth Embodiment

Hereinafter, an exemplary modification of the twelfth embodiment will be described with reference to the drawings. Hereinafter, differences from the twelfth embodiment will be mainly described. Specifically, in the exemplary modification of the twelfth embodiment, as shown in FIG. 48, a reflective polarization plate 360 is a transmissive region 440. That is, the reflective polarization plate 360 is employed as the transmissive region 440.

(Function(s) and Advantageous Effect(s))

In the exemplary modification of the twelfth embodiment, the reflective polarization plate 360 is employed as the transmissive region 440. Therefore, it is possible to reduce the number of parts in the projection display apparatus 100 and downsize the projection display apparatus 100.

### Thirteenth Embodiment

Hereinafter, a thirteenth embodiment will be described with reference to the drawings. Hereinafter, differences between the twelfth embodiment and the thirteenth embodiment will be mainly described.

Specifically, in the thirteenth embodiment, as shown in FIG. 49, a reflective polarization plate 360 is employed as a transmissive region 440, like the exemplary modification of the twelfth embodiment.

The projection optical unit 300 has a reflection mirror 340 provided on an optical path of image light transmitting the reflective polarization plate 360 (transmissive region 440). The reflection mirror 340 is provided on the optical path of the image light transmitting the reflective polarization plate 360 (transmissive region 440). The reflection mirror 340 reflects the image light transmitting the reflective polarization plate 360 (transmissive region 440) to the side of a projection plane 220. It is preferable that the reflection mirror 340 is provided as part of the protection cover 400.

(Image Display Example(s))

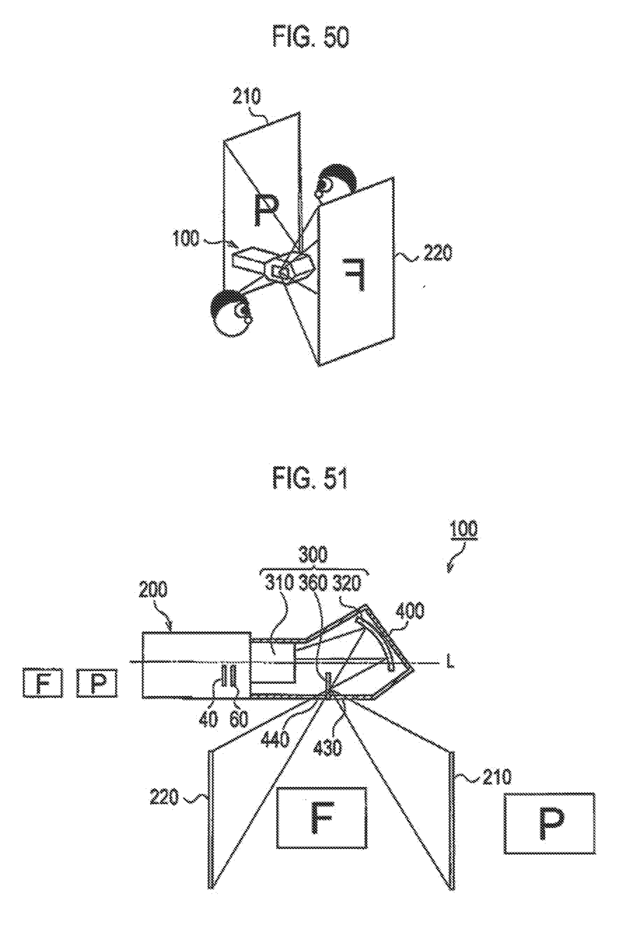

Hereinafter, an image display example according to the thirteenth embodiment will be described with reference to the drawings. FIG. 50 is a view showing the image display example according to the thirteenth embodiment.

Here is illustrated a case in which a projection display apparatus 100 is disposed so that a transmissive region 430 and a transmissive region 440 are provided at the left and right sides of the projection display apparatus 100. In addition, there is illustrated a case in which a display element 40 is disposed so as to be longer in a vertical direction than in a horizontal direction.

As shown in FIG. 50, screens of same type (reflective screens) can be employed as the projection plane 210 and the projection plane 220. In addition, longer images in a vertical direction than in a horizontal direction are displayed on the projection plane 210 and the projection plane 220.

(Function(s) and Advantageous Effect(s))

In the thirteenth embodiment, the reflection mirror 340 reflects the image light transmitting the reflective polarization plate 360 (transmissive region 440) to the side of the projection plane 220. Therefore, as the projection plane 210 and the projection plane 220, screens of given type can be employed on different planes irrespective of whether they are of transmissive or reflective type. In addition, different images can be displayed on the projection plane 210 and the projection plane 220.

A center of a passageway is considered as a setup site of the projection display apparatus 100. In this manner, images can be displayed on both wall faces of the passageway.

A revolving shaft of a revolving door is considered as a setup site of the projection display apparatus 100. In this manner, an image can be shown to a plurality of pedestrians passing through the revolving door.

A wall interior having its thickness which is capable of housing the projection display apparatus 100 is considered as a setup site of the projection display apparatus 100. In this manner, images can be displayed at the front and back faces of wall.

### Fourteenth Embodiment

Hereinafter, a fourteenth embodiment will be described with reference to the drawings. Hereinafter, differences between the twelfth embodiment and the fourteenth embodiment will be mainly described.

Specifically, in the fourteenth embodiment, as shown in FIG. 51, a transmissive region 430 is provided on a side face of a protection cover 400 in the same manner as that in a transmissive region 440.

A reflective polarization plate 360 has an inclination which is substantially vertical relative to the side face of the protection cover 400 on which a transmissive region 430 and a transmissive region 440 are provided. The inclination of the reflective polarization plate 360 is not limitative to being substantially vertical relative to the side face of the protection cover 400 on which a transmissive region 430 and a transmissive region 440 are provided. The inclination of the reflective polarization plate 360 may be a given inclination.

Like the twelfth embodiment, the transmissive region 430 transmits the first image light reflected by the reflective polarization plate 360 to the side of the projection plane 210. The transmissive region 440 transmits the second image light transmitting the reflective polarization plate 360 to the side of the projection plane 220.

Here, the projection plane 210 is a transmissive screen for displaying an image by way of transmission of image light, for example. The projection plane 220 is a reflective screen for displaying an image by way of reflection of image light, for example.

However, a first image or a second image that a liquid crystal panel 40 displays is laterally inverted, whereby the orientations of images displayed on the projection plane 210 and the projection plane 220 can be coordinated. Therefore, screens of given type (reflective or transmissive screens) can be employed as the projection plane 210 and the projection plane 220.

(Image Display Example(s))

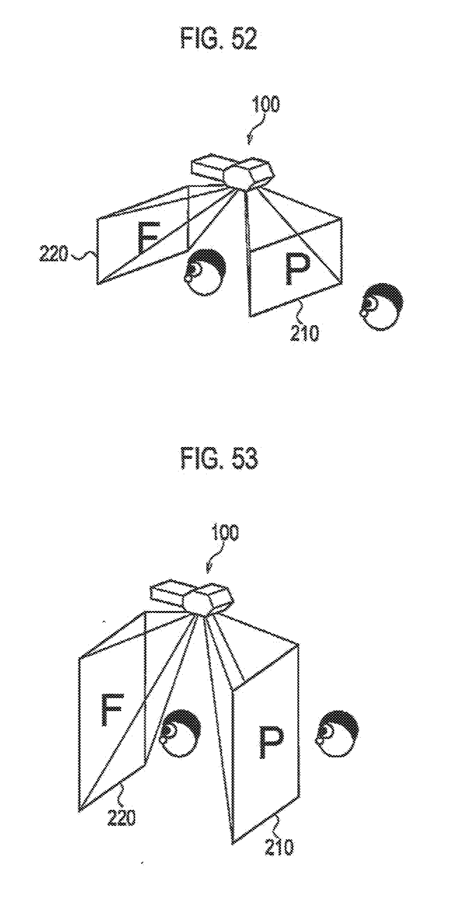

Hereinafter, image display examples according to the fourteenth embodiment will be described with reference to the drawings. FIG. 52 and FIG. 53 are views showing the image display examples according to the fourteenth embodiment. Here is illustrated a case in which a projection display apparatus 100 is disposed so that a transmissive region 430 and a transmissive region 440 are provided at the lower side of the projection display apparatus 100.

As shown in FIG. 52, in a case in which a display element 40 is provided so as to be longer in a horizontal direction than in a vertical direction, longer images in a horizontal direction than in a vertical direction are displayed on the projection plane 210 and the projection plane 220.

On the other hand, as shown in FIG. 53, in a case in which the display element 40 is provided so as to be longer in a vertical direction than in a horizontal direction, longer images in a vertical direction than in a horizontal direction are displayed on the projection plane 210 and the projection plane 220.

The fourteenth embodiment illustrated a case in which the projection display apparatus 100 is disposed so that the transmissive region 430 and the transmissive region 440 are provided at the lower side of the projection display apparatus 100. However, the disposition of the projection display apparatus 100 is not limitative thereto. The projection display apparatus 100 may be disposed so that the transmissive region 430 and the transmissive region 440 are provided at the upper side of the transmissive display apparatus 100, for example. The projection display apparatus 100 may also be disposed so that the transmissive region 430 and the transmissive region 440 are provided at the lateral side of the transmissive display apparatus 100.

(Function(s) and Advantageous Effect(s))

In the fourteenth embodiment, the transmissive region 430 is provided at the side face of the protection cover 400 in the same manner as that in the transmissive region 440. In this manner, images can be displayed in two sites on different planes at the lower side, the upper side, or the lateral side of the projection display apparatus 100. Different images can also be displayed on the projection plan 210 and the projection plane 220.

In a case where the transmissive region 430 and the transmissive region 440 are provided at the lower side of the projection display apparatus 100, a building's ceiling is considered as a setup site of the projection display apparatus 100. In this manner, images can be displayed on a plurality of walls provided in building.

In a case where the transmissive region 430 and the transmissive region 440 are provided at the upper side of the projection display apparatus 100, a building's floor is considered as a setup site of the projection display apparatus 100. In this manner, images can be displayed on a plurality of walls provided in building.

### Other Embodiments

While the present invention has been described by way of the foregoing embodiments, it should not be understood that the statements and drawings forming a part of this disclosure limit the invention. From this disclosure, a variety of alternative embodiments, examples, and applicable techniques would have been apparent to one skilled in the art.

Although not set forth in the foregoing embodiments in particular, a reflection mirror 320 focuses image light between a reflection optical element 330 and a projection plane 210, in a first state. It is preferable that a first opening portion 410 is provided in proximity to a position at which image light is to be focused by the reflection mirror 320. Similarly, the reflection mirror 320 focuses image light between the reflection mirror 320 and the projection plane 210, in a second state. It is preferable that a second opening portion 420 is provided in proximity to a position at which image light is to be focused by the reflection mirror 320.

While the foregoing embodiments illustrated a case in which a non-spherical mirror is employed as a reflection mirror 320, the reflection mirror 320 is not limitative thereto. For example, a free curved mirror may be employed as the reflection mirror 320, for example. A spherical mirror may be employed as the reflection mirror 320 as long as any contrivance is made as to aberration or resolution.

While the foregoing embodiments illustrate a case in which a plurality of display elements 40 (triple-plate system) are employed as constituent elements shown in an image light generating unit 200, the constituent elements shown in the image light generating unit 200 are not limitative thereto. A single display element 40 (single-plate system) may be employed as a constituent element of the image light generating unit 200.

While the foregoing embodiments illustrated a case in which a reflection optical element 330 is a reflection mirror, the reflection optical element 330 is not limitative thereto. The reflection optical element 330 may be a half mirror for reflecting one portion of image light and transmitting another portion of the image light. The reflection optical element 330 may be a reflective polarization plate for reflecting image light having the first polarization and transmitting light having the second polarization.

In such a case, if a state of the reflection optical element 330 is a first state, the reflection optical element 330 may be adapted to reflect image light of one portion to the side of the first opening portion 410 and transmit image light of another portion to the side of the second opening portion 420, out of the image light reflected by the reflection mirror 320. In this manner, an image is displayed on a first projection plane by means of the image light of one portion transmitting the first opening portion 410, whereas an image is displayed on a second projection plane by means of the image light of another pardon transmitting the second opening portion 420. That is, the projection display apparatus 100 can display images at two sites.

In the foregoing embodiments, in a case where the projection display apparatus 100 is of floor-placed setup type, the state of the reflection optical element 330 corresponds to a first state, and in a case where the projection display apparatus 100 is of ceiling-suspended setup type, the state of the reflection optical element 300 corresponds to a second state. However, depending upon the configuration of the projection display apparatus 100, the state of the reflection optical element 330 may correspond to the second state in the case where the projection display apparatus 100 is of floor-placed setup type, whereas the state of the reflection optical element 330 may correspond to the first state in the case where the projection display apparatus 100 is of ceiling-suspended setup type.

Although not set forth in the foregoing embodiments, a projection plane 210 may be any plane as long as image light is projected thereon. Therefore, the projection plane 210 may not be a screen used exclusively for a projection display apparatus. For example, the projection plane 210 may be a wall surface, a floor surface, a ceiling, a glass window or the like.

According to each of the embodiments, as described above, a distance between a projection display apparatus and a projection plane is shortened by providing a reflection mirror 320. Therefore, image light can be restrained from being interrupted by a person or the like standing between the projection display apparatus and the projection plane. In addition, in a case where a laser diode (LD) is employed as a light source 10, a possibility that a person is irradiated with laser beam (image light) can be reduced.

Although not set forth in the foregoing embodiment in particular, at least a part of the protection cover 400 may be comprised of an optically transmissive member such as a transmissive resin or a glass. A transmissive region 430 may be comprised of such an optically transmissive member. Similarly, a transmissive region 440 may be comprised of such an optically transmissive member.

Although not set forth in the foregoing embodiments in particular, the reflection mirror 320 focuses one portion of the image light emitted from the image light generating unit 200 between the half mirror 350 and the projection plane 210. It is preferable that the transmissive region 430 is provided in proximity to a position at which one portion of the image light is focused by the reflection mirror 320. Similarly, the reflection mirror 320 focuses another portion of the image light emitted from the image light generating unit 200 between the half mirror 350 and the projection plane 220. It is preferable that the transmissive region 440 is provided in proximity to a position at which another portion of the image light is focused by the reflection mirror 320. According to the exemplary modification of the seventh embodiment, it is preferable that the half mirror 350 is provided in proximity to a position at which image light is focused by the reflection mirror 320.

Although not set forth in the foregoing embodiments, as the half mirror 350, a half mirror in which a relationship between a reflection index and a transmission factor is not one-to-one may be employed in a visible light region.

Although not set forth in the foregoing embodiments in particular, as the half mirror 350, there may be employed a dichroic mirror or the like for reflecting light having a wavelength band of one portion and transmitting light having the wavelength band of another portion, of the wavelength band that the image light has. In addition, as the half mirror 350, there may be employed a reflective polarization plate or the like, for reflecting light having one polarization and transmitting light having the other polarization, of the image light. As a case of employing a dichroic mirror or a reflective polarization plate as the half mirror 350, there is considered a case of displaying images of different colors on the projection plane 210 and the projection plane 220.

Although not set forth in the foregoing embodiments in particular, the first reflective region 321 focuses the first image light emitted from the image light generating unit 200 between the first reflective region 321 and the projection plane 210. It is preferable that the transmissive region 430 is provided in proximity to a position at which the first image light is focused by the first reflective region 321. Similarly, the second reflective region 322 focuses the second image light emitted from the image light generating unit 200 between the second reflective region and the projecting plane 220. It is preferable that the transmissive region 440 is provided in proximity to a position at which the second image light is focused by the second reflective region 322.

According to the eleventh embodiment, it is preferable that a first half 351 is provided in proximity to a position at which the first image light is focused by the first reflective region 321. It is preferable that a second half mirror 352 is provided in proximity to a position at which the second image light is focused by the second reflective region 322.

Although not set forth in the foregoing embodiments in particular, a protection cover 400 may have an opening communication from the reflective polarization plate 360 to the side of the projection plane 210. The transmissive region 430 may be such an opening. Similarly, the protection cover 400 may have an opening communicating from the reflective polarization plate 360 to the side of the projection plane 220. The transmissive region 440 may be such an opening.

Although not set forth in the foregoing embodiments in particular, at least part of the protection cover 400 may be comprised of an optically transmissive member such as a transmissive resin or a glass. The transmissive region 430 may be comprised of such an optically transmissive member. Similarly, the transmissive region 440 may be comprised of such an optically transmissive member.

Although not set forth in the foregoing embodiments in particular, the reflection mirror 320 focuses the first image light emitted from the image light generating unit 200 between the reflective polarization plate 360 and the projection plane 210. It is preferable that the transmissive region 430 is provided in proximity to a position at which the first image light is focused by the reflection mirror 320. Similarly, the reflection mirror 320 focuses the second image light emitted from the image light generating unit 200 between the reflective polarization plate 360 and the projection plane 220. It is preferable that the transmissive region 440 is provided in proximity to a position at which the second image light is focused by the reflection mirror 320. According to the exemplary modification of the twelfth embodiment, it is preferable that the reflective polarization plate 360 is provided in proximity to a position at which the image light is focused by the reflection mirror 320.

While, in the foregoing embodiments, a polarization adjusting element 60 is provided in an image light generating unit 200, the disposition of the polarization adjusting element 60 is not limitative thereto. For example, the polarization adjusting element 60 may be provided before image light is incident to the reflective polarization plate 360, on the optical path of the image light emitted from the image light generating unit 200.

### INDUSTRIAL APPLICABILITY

According to the present invention, there can be provided a projection display apparatus which is capable of appropriately maintaining disposition precision of a reflection mirror provided to reduce a distance between the projecting display apparatus and a projection plane.

1. A projection display apparatus, comprising:
an image light generating unit configured to generate image light; and
a projection optical unit configured to project the image light on a projection plane, wherein:
the projection optical unit has a reflection mirror formed in a concaved shape, configured to reflect the image light emitted from the image light generating unit and focusing the image light;
the projection optical unit has an optical element configured to project the image light in a plurality of directions without changing disposition of the projection display apparatus; and
the optical element is provided in a protection cover for housing the reflection mirror.

2. The projection display apparatus set forth in claim 1, wherein:
a reflection optical element configured to reflect the image light reflected by the reflection mirror, is provided as the optical element;
a support mechanism configured to support the reflection optical element while a first state and a second state can be switched as a state of the reflection optical element;
the first state is a state in which the reflection optical element is disposed on an optical path of the image light reflected by the reflection mirror;
the second state is a state in which the reflection optical element is caused to come off from a course of the optical path of the image light reflected by the reflection mirror; and
the projection optical unit projects on the projection plane the image light reflected by the reflection optical element in the first state, and projects on the projection plane the image light reflected by the reflection mirror in the second state.

3. The projection display apparatus set forth in claim 2, wherein:
the protection cover is provided on an optical path of the image light reflected by the reflection mirror;
the protection cover has an opening portion configured to transmit the image light;
the opening portion includes a first opening portion configured to transmit the image light on a side of the projection plane in the first state, and a second opening pardon configured to transmit the image light on the side of the projection plane in the second state.

4. The projection display apparatus set forth in claim 3, further comprising an opening control section configured to control the opening portion, wherein:
the opening portion has an opening configured to transmit the image light and a capping member configured to close the opening; and
the opening control section controls whether or not the opening is dosed by the capping member, in accordance with a state of the reflection optical element.

5. The projection display apparatus set forth in claim 2, further comprising an image control section configured to control an image displayed on the projection plane, wherein
the image control section controls an orientation of the image displayed on the projection plane, in accordance with the state of the reflection optical element.

6. The projection display apparatus set forth in claim 3, wherein:
the reflection mirror focuses the image light between the reflection optical element and the projection plane in the first state, and focuses the image light between the reflection mirror and the projection plane in the second state; and
the first opening portion and the second opening portion are disposed in proximity to a position at which the image light is focused.

7. The projection display apparatus set forth in claim 1, wherein:
the projection optical unit has, as the optical element, a half mirror provided on the optical path of the image light reflected by the reflection mirror;
the reflection mirror focuses the image light emitted from the image light generating unit; and
the half mirror reflects one portion of the image light reflected by the reflection mirror, and transmits another portion of the image light reflected by the reflection mirror.

8. The projection display apparatus set forth in claim 1, wherein:
the image light generating unit has a display element configured to generate the image light;
the display element has a first display region and a second display region;
the reflection mirror has:
a first reflective region configured to reflect first image light emitted from the first display region and focusing the first image light; and
a second reflective region configured to reflect, second image light emitted from the second display region and focusing the second image light; and
the reflection mirror is provided as the optical element.

9. The projection display apparatus set forth in claim 1, wherein:
the image light generating unit has a display element configured to generate the image light, and the generating section further comprising a polarization adjusting element provided on an optical path of the image light emitted from the display element;
the projection optical unit has a reflection mirror configured to reflect the image light emitted from the display element,
the projection display apparatus further comprising, as the optical element, a reflective polarization plate provided on the optical path of the image light emitted from the display element;
the reflection mirror focuses the image light emitted from the image light generating unit;
the display element displays a first image and a second image in time division;
the polarization adjusting element adjusts first image light which corresponds to the first image, into first polarization, and adjusts second image light which corresponds to the second image, into second polarization, of the image light emitted from the display element; and
the reflective polarization plate reflects the first image light adjusted into the first polarization, and transmits the second image light adjusted into the second polarization.
